(19) United States
(12) Patent Application Publication
(10) Pub. No.: US 2012/0209855 A1
(43) Pub. Date: Aug. 16, 2012

(54) BIT-STRING KEY CLASSIFICATION/DISTRIBUTION APPARATUS, CLASSIFICATION/DISTRIBUTION METHOD, AND PROGRAM

(75) Inventors: TOSHIO SHINJO, Chiba (JP); Mitsuhiro Kokubun, Chiba (JP)

(73) Assignee: S. Grants Co., Ltd., Chiba (JP)

(21) Appl. No.: 13/456,955

(22) Filed: Apr. 26, 2012

Related U.S. Application Data
(63) Continuation of application No. PCT/JP2010/006305, filed on Oct. 25, 2010.

(30) Foreign Application Priority Data
Oct. 27, 2009 (JP) 2009-246868

(51) Int. Cl. G06F 17/30

(52) U.S. Cl. 707/745; 707/E17.012

(57) ABSTRACT

When keys are to be classified into a plurality of blocks, to provide a classification method wherein the range of key values does not overlap and a method for distributing the classified keys by applying the art of a coupled-node tree. Keys are successively selected as classification keys from a key storage means holding the keys to be classified, and a classification tree, which is an application of a coupled-node tree, is generated by means of the classification keys, and the classification is done by making a correspondence between its leaf nodes and the keys to be classified into each of N blocks. The number of levels in the classification tree is constrained as a function of the block number N. A leaf node is extracted from the classification tree and the corresponding key is extracted as a classified key and distributed.

### CROSS-REFERENCE TO RELATED APPLICATIONS

This application is a continuation of PCT/JP2010/006305 filed on Dec. 25, 2010.

PCT/JP2010/006305 is based on and claims the benefit of priority of the prior Japanese Patent Application 2009-246868 filed on Dec. 27, 2009, the entire contents of which are incorporated by reference. The contents of PCT/JP2010/006305 is incorporated by reference.

### BACKGROUND OF THE INVENTION

1. Field of the Invention

This invention relates to the technology for classifying bit-string keys to be classified and to the technology for distributing the classified keys to an output target.

2. Description of Related Art

In recent years, with advancements in information-based societies, large-scale databases have come to be used in various places. To search such large-scale databases, it is usual to search for a desired record, retrieving the desired record by using as indexes items within records associated with the addresses at which each record is stored. Character strings in full-text searches can also be treated as index keys.

Then, because the index keys can be expressed as bit strings, the searching of a database is reduced to searching for bit strings in the database.

Furthermore, the processing of a database, as recited in the patent document 1 and patent document 2 cited below, includes merge sorting of the records in the database. This merge sort is also reduced to a merge sort of bit strings.

A basic merge sort method consists of dividing the data into pairs of 2, ordering the pair, and then combining the ordered pairs. In other words, the process is divided into an initial stage of repeatedly dividing the data to be sorted and sorting them, thus obtaining several groups of sorted data, and a later stage of repeatedly merging the sorted data, thus sorting completely the data to be sorted.

Patent document 2 discloses the processing shown in FIG. 1, of the latter stage of the merge sort processing. As shown in FIG. 1, sorted data is stored in block 1 to block N, and the minimum value in block 1 is 13, the minimum value in block 2 is 8 and the next data value is 22. In the same way, the example shows that the minimum value in block 3 is 53, the minimum value in block 4 is 24, and the minimum value in block N is 9.

The latter stage processing of a merge sort assumes the existence of the above described block 1 to block N. Thus the data must be classified into N blocks in order to execute the merge sort shown in FIG. 1.

Then, as shown in FIG. 1, a merge sort is realized by extracting the smallest value from each block and generating a data array from the smallest value in each block.

Meanwhile, as shown in FIG. 1, in the methods heretofore of classifying data into N blocks, the range of the data classified into each block overlaps. Thus even if the sort within a block is sped up by making the size of each block to fit into cache memory, high speed processing using cache memory cannot be used in the latter stage of merge sort processing of the data within each block because all of the data to be sorted has to be sorted.

On the contrary, the patent document 3 below discloses an example of storing a coupled-node tree in an array as a data configuration used in a search for bit-string data. Storing the coupled-node tree in an array allows the node positions to be expressed as an array element numbers and enables the amount of information needed to express the position of primary nodes to be reduced.

Also, the patent document 4 below discloses methods for searching for the smallest value or the largest value in any arbitrary subtree in a coupled-node tree and methods for extracting index keys in ascending or descending sequence from any arbitrary subtree in a coupled-node tree. Hereinbelow, a coupled-node tree is described, referencing FIG. 2A and FIG. 2B, as one kind of art related to this invention.

FIG. 2A is a drawing that describes an exemplary configuration of a coupled node tree that is stored in an array, recited in patent document 3. As shown in FIG. 2A, a node 101 is located at the array element of the array 100 with the array element number 10. The node 101 is formed by a node type 102, a discrimination bit position 103, and a coupled node indicator 104. The value in the node type 102 is 0, which indicates that the node 101 is a branch node. The value 1 is stored in the discrimination bit position 103. The coupled node indicator 104 has stored in it the array element number 20 of the primary node of the node pair of the link target. To simplify notation hereinafter, the array element number stored in a coupled node indicator is sometimes called the coupled node indicator. Also, the array element number stored in a coupled node indicator is sometimes expressed as the code appended to that node or the code attached to a node pair.

The array element having the array element number 20 has stored therein a node [0] 112, which is the primary node of the node pair 111. Then the node [1] 113 forming a pair with the primary node is stored into the next, adjacent, array element (array element number 20+1). Node [0] 112, like node 101, is a branch node. The value 0 is stored in the node type 114 of the node [0] 112, the value 3 is stored in the discrimination bit position 115, and the value 30 is stored in the coupled node indicator 116. Also node 1 [113] consists of the node type 117 and the reference pointer 118a. The value 1 is stored in the node type 117, thereby indicating that the node 1 [113] is a leaf node. A pointer referencing the index key storage area is stored in reference pointer 118a. Hereinbelow, the data stored in the reference pointer is also called the reference pointer in order to abbreviate the notation.

The contents of the node pair 121 consisting of nodes 122 and 123 stored in the array elements with the array element number 30 and 31 is omitted. Also primary nodes are indicated as the node [0], and nodes that are paired therewith are indicated as the node [1]. Also the node stored in an array element with some array element number is called the node of that array element number and the array element number stored in the array element of that node is also called the array element number of the node. Furthermore, in order to show the relationship between a given leaf node and the index key stored in the storage area shown by the reference pointer in that leaf node we may say the index key associated with the leaf node and we may say the leaf node associated with the index key.

The 0 or 1 prefixed to the array elements of node [0] 112, node [1] 113, node 122, and node 123, respectively, shows to which node in a node pair a link is to be made if a search is performed with a search key. The bit value, 0 or 1, in the search key at the discrimination bit position of the previous stage branch node is added to the coupled node indicator and linking is done to the node with that array element number. Thus, by adding the bit value at the discrimination bit position in the search key to the coupled node indicator of the previous stage branch node, the array element number of the array element holding the node that is the link target can be obtained.

FIG. 2B is a drawing that conceptually describes an embodiment of a tree structure of a coupled node tree as well as showing an example of an area for storing index keys. The reference code 410a shows the root node of the coupled-node tree 400 shown in the example in FIG. 2B. In the example described, the root node 410a is the primary node of the node pair 401a located at the array element number 420. In this tree structure, a node pair 401b is located below the root node 410a, and below that are located the node pair 401c and the node pair 401f. Below the node pair 401f are located the node pair 401h and the node pair 401g. Below the node pair 401c is located the node pair 401d, and below the node pair 401d is located the node pair 401e.

The 0 or 1 code that is appended before each node is the same as the codes that are appended before the array element numbers described in FIG. 2A. The tree is traversed in accordance with the bit values at discrimination bit positions of the search key, so that the leaf node of the sought for item is found.

In the example described, the node type 460a of the root node 410a is 0, thereby indicating that this is a branch node, and the discrimination bit position 430a indicates 0. The coupled node indicator is 420a, which is the array element number of the array element in which the primary node 410b of the node pair 401b is stored.

The node pair 401b is formed by the node 410b and the node 411b, the node types 460b and 461b thereof both being 0, indicating branch nodes. The discrimination bit position 430b of the node 410b has 1 stored therein, and in the coupled node indicator of the link target is stored the array element number 420b of the array element in which is stored the primary node 410c of the node pair 401c.

Because 1 is stored in the node type 460c of the node 410c, this node is a leaf node, and thus includes the reference pointer 450c. In the reference pointer 450c is stored a pointer that references the storage area wherein is stored the index key 270c. The data stored in the reference pointer 450c is also called the reference pointer and is shown by the reference code 480c. The same applies to the other leaf nodes: the same word, reference pointer, is used to refer both to the reference pointer and to the data stored in the reference pointer. The value “000111” is stored as an index key in the area pointed to by the reference pointer 480c to the index key storage area 311 shown in FIG. 2B.

The node type 461c of the node 411c is 0, the discrimination bit position 431c of the node 411c is 2, and in the coupled node indicator is stored the array element number 421c of an array element in which is stored the primary node 410d of the node pair 401d.

The node type 460d of the node 410d is 0, the discrimination bit position 430d of the node 410d is 5, and in the coupled node indicator is stored the array element number 420d of an array element in which is stored the primary node 410e of the node 401e. The node type 461d of the node 411d that is paired with the node 410d is 1, and “011010” is stored in the index key 271d, which is stored in the storage area shown by the reference pointer 481d.

The node types 460e and 461e of the nodes 410e and 411e of the node pair 401e are both 1, indicating that both are leaf nodes. In the reference pointers 450e and 451e of the nodes 410e and 411e are stored the reference pointers 480e and 481e which point to the storage areas wherein are stored the index key 270e with the value “010010” and the index key 271e with the value 010011, respectively.

The discrimination bit position 431b of the node 411b, which is the other node of the node pair 401b, has a 2 stored therein, and the array element number 421b of the array element in which is stored the primary node 410f of the node pair 401f is stored in the coupled node indicator of the link target.

The node types 460f and 461f of the nodes 410f and 411f of the node pair 401f are both 0, indicating that both are branch nodes. In the discrimination bit positions 430f and 431f of each are stored a 5 and a 3, respectively. The array element number 420f of the array element in which is stored the primary node 410g of the node pair 401g is stored in the coupled node indicator of the node 410f, and the array element number 421f of an array element in which is stored the node [0] 410h, which is the primary node of the node pair 401h, is stored in the coupled node indicator of the node 411f.

The node types 460g and 461g of the nodes 410g and 411g of the node pair 401g are both 1, indicating that both are leaf nodes. In the reference pointers 450g and 451g of the nodes 410g and 411g are stored the reference pointers 480g and 481g which point to the storage areas wherein are stored the index key 270g with the value “100010” and the index key 271g with the value “100011”, respectively.

In the same manner, the node types 460h and 461h of the node [0] 410h of the node pair 401h, and the node [1] 411h, which is paired therewith, are both 1, indicating that both are leaf nodes. In the reference pointers 450h and 451h of the nodes 410h and 411h are stored the reference pointers 480h and 481h which point to the storage areas wherein are stored the index key 270g with the value “101011” and the index key 271g with the value “101100”, respectively.

The processing flow in searching for the index key “100010” from the above-noted tree 400 is briefly described below. The discrimination bit positions are numbered 0, 1, 2, . . . and so on from the left. First, processing is started from the root node 410a using the bit string “100010” as the search key. Because the discrimination bit position 430a of the root node 410a is 0, examining the bit value of the discrimination bit position 0 reveals 1. This being the case, 1 is added to the array element number 420a stored in the coupled node indicator and linking is done to the node 411b stored in the resulting array element number. Because 2 is stored in the discrimination bit position 431b of the node 411b, examination of the bit value of the discrimination bit position 2 reveals 0, resulting in linking to the node 410f stored in the array element having the array element number 421b stored in the coupled node indicator.

Because 5 is stored in the discrimination bit position 430f of the node 410f, and because examination of the bit value of the discrimination bit position 5 of the search key “100010” reveals 0, linking is done to the node 410g stored in the array element having the array element number 420f stored in the coupled node indicator.

Because the node type 460g of the node 410g is 1, indicating a leaf node, the storage area shown by the reference pointer 480g is referenced and the index key 270g stored therein is read out and a comparison is performed with the search key. Both the index key 270g and the search key are “100010”, thus coinciding. In this way, searching is performed using the coupled node tree.

A search using the coupled-node tree 400 described above can be seen as the processing to classify 8 index keys into a group corresponding to 8 leaf nodes respectively. In other words, patent document 3 can also be thought to disclose an index key classification method wherein there is 1 index key in a block. However, the classification method for index keys when there are a plurality of index keys in a block, which presumes the latter stage processing of the above noted merge sort, is not disclosed.
Patent document 1: JP 2000-010761 A
Patent document 2: JP 2006-163565 A
Patent document 3: JP 2008-269503 A
Patent document 4: JP 2008-112240 A

### SUMMARY OF THE INVENTION

Thus, the problem to be solved by this invention is, when data consisting of a bit string (Hereinbelow this may be called a bit-string key or simply a key. It also may be called an index key.) is to be classified into a plurality of blocks, to provide a classification method such that the ranges of the key values do not overlap and a distribution method for outputting the classified bit-string keys to an output target, applying the art of a coupled-node tree.

In accordance with this invention, a classification method that classifies bit-string keys into N blocks successively selects, as a classification key, keys from a key storage means that holds the keys to be classified, and generates, by means of the classification key, a classification tree that is an application of the art of a coupled-node tree, and associates its leaf nodes with the keys to be classified each into N blocks. The number of levels in the classification tree is restricted as a function of the number N of the blocks.

In accordance with one embodiment of this invention, the leaf nodes in the classification tree include key access information used to obtain position information for classification keys stored in a key storage means. Then a key position search table for obtaining the key position information is generated using the key access information. The number of levels n in the classification tree is limited to the value for which 2 to the power of (n−1) is equal to the number of blocks N or is the smallest value larger than N. For example if N=8, then n=4.

In accordance with one embodiment of this invention, a leaf node is successively extracted from the classification tree generated from all the keys to be classified, and using the key access information read out from the leaf node, position information for classified keys in the block associated with the leaf node is obtained from the key position search tables, and the classified keys are read out from the key storage means and output to the output target.

Due to a special characteristic of a coupled-node tree, the higher level bit values in a key up to the discrimination bit position in the branch node immediately above a given leaf node coincide with those for any key classified in the same block, and any key with a bit value differing up to the discrimination bit position in the branch node immediately above that leaf node is classified in a different block. Thus, in accordance with this invention, keys can be effectively classified in such a way that the range of the values of the keys to be classified does not overlap, by generating a classification tree that has the structure of a coupled-node tree.

### BRIEF DESCRIPTION OF THE DRAWINGS

FIG. 1 is a drawing describing the processing that repeatedly merges sorted data and thus completely sorts the data to be sorted.

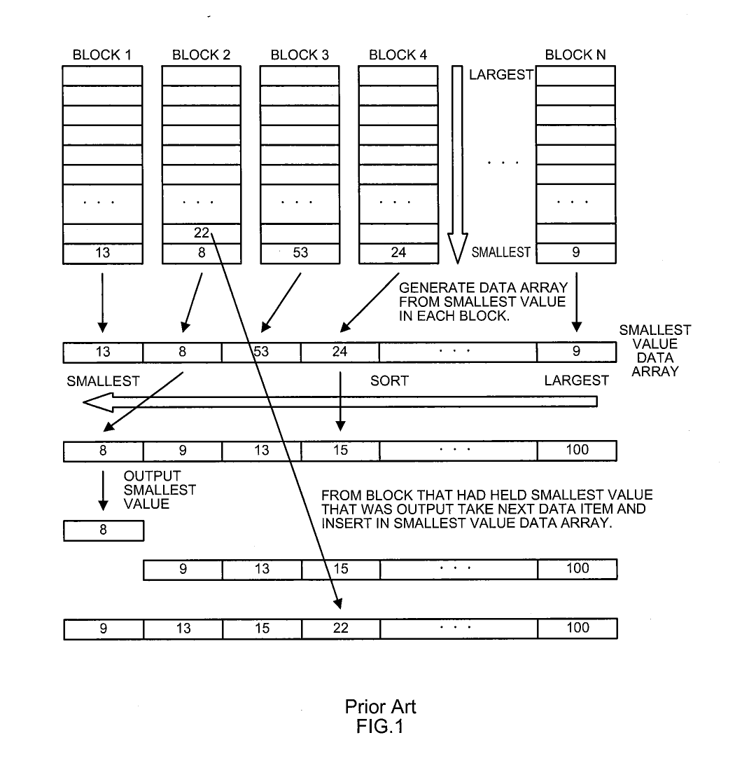

FIG. 2A is a drawing describing an exemplary configuration of a coupled node tree stored in an array.

FIG. 2B is a drawing showing conceptually the tree configuration of a coupled node tree.

FIG. 3 is a drawing describing an overview of the classification processing in a preferred embodiment of this invention.

FIG. 4 is a drawing describing an exemplary hardware configuration for implementing this invention.

FIG. 5 is a drawing describing conceptually the tree configuration of a classification tree as well as the area for managing index keys, related to a preferred embodiment of this invention.

FIG. 6A is a drawing describing the status before the classification key “010011” is inserted.

FIG. 6B is a drawing describing the status after the classification key “010011” is inserted and before the classification key “010010” is inserted.

FIG. 6C is a drawing describing the status after the classification key “010010” is inserted and before the classification key “000111” is inserted.

FIG. 6D is a drawing describing the status after the index key has been linked to the key link table for the leaf node at the insertion position for inserting a node pair.

FIG. 6E is a drawing describing the status after the index key has been linked to the key link table for the leaf node at the insertion position and the classification key “000111” is inserted.

FIG. 7A is a drawing showing an example of the processing flow in classification processing in a preferred embodiment of this invention.

FIG. 7B is a drawing showing an example of the processing flow in distribution processing in a preferred embodiment of this invention.

FIG. 8 is a drawing describing an example of the processing flow for generating a classification tree by means of a classification key in a preferred embodiment of this invention.

FIG. 9A is a drawing showing an example of the processing flow for the initial stage of the processing for inserting a classification key in the classification tree in a preferred embodiment of this invention.

FIG. 9B is a drawing showing an example of the processing flow for the middle stage of the processing for inserting a classification key in the classification tree in a preferred embodiment of this invention.

FIG. 9C is a drawing showing an example of the processing flow for the last stage of the processing for inserting a classification key in the classification tree in a preferred embodiment of this invention.

FIG. 10 is a drawing showing an example of the processing flow for inserting a classification key in the insertion position in a preferred embodiment of this invention.

FIG. 11 is a drawing showing an example of the processing flow to link a classification key to the key link table for the leaf node in a preferred embodiment of this invention.

FIG. 12 is a drawing describing an example of the processing flow to search the classification tree and link the classification key to the key link table for the leaf node in a preferred embodiment of this invention.

FIG. 13 is a drawing describing an example of the processing flow to search for the node with the smallest index key in a preferred embodiment of this invention.

FIG. 14 is a drawing describing an example of the processing flow to link the classification reference pointers for the leaf nodes of node pair in a preferred embodiment of this invention.

FIG. 15A is a drawing describing an example of the processing flow in the prior stage of the processing to obtain the leaf node with the smallest index key and to successively extract index keys that are linked to the key link table for the leaf node in a preferred embodiment of this invention.

FIG. 15B is a drawing describing an example of the processing flow in the latter stage of the processing to obtain the leaf node with the smallest index key and to successively extract index keys that are linked to the key link table for the leaf node in a preferred embodiment of this invention.

FIG. 16 is a drawing describing an example of a function block configuration for a bit-string key classification/distribution apparatus in a preferred embodiment of this invention.

### DETAILED DESCRIPTION OF THE INVENTION

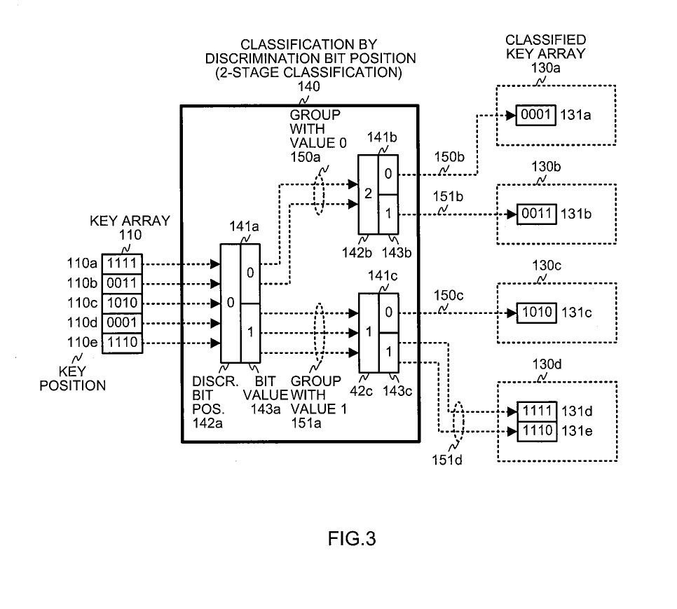

FIG. 3 is a drawing describing an overview of the classification processing in a preferred embodiment of this invention. FIG. 3 shows keys classified into 4 blocks. Thus the classification tree has two levels.

FIG. 3 shows a key array 110 consisting of the keys to be classified. In the example shown in FIG. 3, a key “1111” exists in the storage area for which the key position, which is the position of a key existing among the keys included in key array 110, is 110a (Hereinbelow this will be notated as key position 110a). Also the keys “0011”, “1010”, “0001”, and “1110” exist in the key positions 110b, 110c, 110d, and 110e respectively.

In the example shown in FIG. 3, in order to classify the keys included in key array 110 into the 4 blocks of classified key arrays 130a, 130b, 130c, and 130d, they are classified by the classification by discrimination bit position (for 2 levels of classification) 140. Even if they were to be classified into 3 blocks, because it is sufficient to first classify them into 4 blocks by the classification by discrimination bit position (for 2 levels of classification) 140 and then to merge the classified contents of 2 adjacent blocks into 1 block, even making the number of blocks to be 2 to the power n does not cause a loss of generality.

The discrimination bit position 142a used in the classification at classification by discrimination bit position 141a, which is the first level in classification by discrimination bit position (for 2 levels of classification) 140, is 0. Those of the index keys whose value in bit value 143a at bit position 0 is 0 are further classified by classification by discrimination bit position 141b at the second level, as shown by the dotted-line arrow group 150a. Conversely, those of the index keys whose value in bit value 143a at bit position 0 is 1 are further classified by classification by discrimination bit position 141c at the second level, as shown by the dotted-line arrow group 151a.

The discrimination bit position 142b used in the classification at classification by discrimination bit position 141b at the second level is 2. Of the index keys that are to be classified by classification by discrimination bit position 141b at the second level, the index key “0001” wherein the value in bit value 143b at bit position 2 is 0 is stored in classified key array 130a as classified key 131a, as shown by the dotted-line arrow 150b. Also of the index keys that are to be classified by classification by discrimination bit position 141b at the second level, the index key “0011” wherein the value in bit value 143b at bit position 2 is 1 is stored in classified key array 130b as classified key 131b, as shown by the dotted-line arrow 151b.

Conversely, the discrimination bit position 142c used in the classification at classification by discrimination bit position 141c at the second level is 1. Of the index keys that are to be classified by classification by discrimination bit position 141c at the second level, the index key “1010” wherein the value in bit value 143c at bit position 1 is 0 is stored in classified key array 130c as classified key 131c, as shown by the dotted-line arrow 151c. Also, of the index keys that are to be classified by classification by discrimination bit position 141c at the second level, the index keys “1111” and “1110” wherein the value in bit value 143c at bit position 2 is 1 are stored in classified key array 130d as classified keys 131d and 131e respectively, as shown by the dotted-line arrow group 151d.

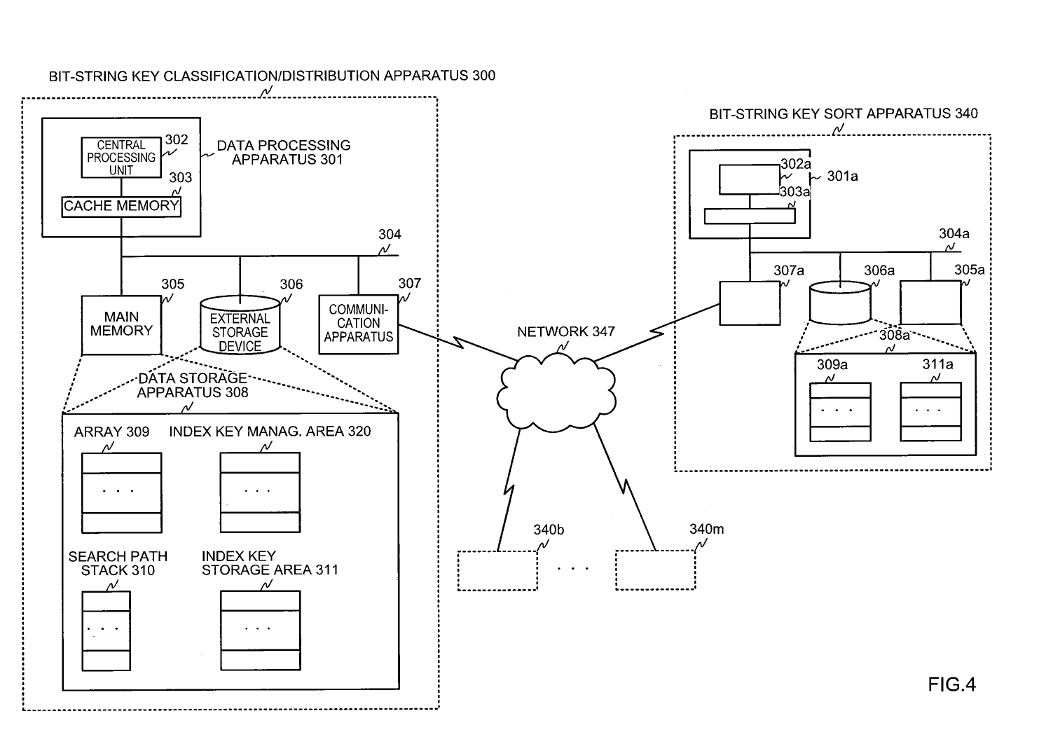

FIG. 4 is a drawing describing an exemplary hardware configuration for implementing this invention. FIG. 4 depicts an example of a system wherein bit-string key classification/distribution apparatus 300 is connected to the bit-string key sort apparatuses 340a, 340b, . . . 340m via network 347. The bit-string key sort apparatus that is the distribution target of the bit-string keys classified by the bit-string key classification/distribution apparatus 300 is just one example of such a target, and other applications like aggregation are also applicable.

Also, the apparatus that is the target of distribution is also not limited to being connected via a network, and, for example, can be made to be the central processing unit in a multiprocessing system.

Classification in accordance with this preferred embodiment is implemented by a data processing apparatus 301 having at least a central processing unit 302 and a cache memory 303, and using a data storage apparatus 308. Also the distribution of sorted keys by data processing apparatus 301 to the bit-string key sort apparatuses 340a, 340b, . . . 340m can also be implemented using data storage apparatus 308. The data storage apparatus 308, which has an array 309 wherein is stored the classification tree, a search path stack 310, into which are stored array element numbers of array elements holding nodes which are traversed during the search on the classification tree, and an index key management area 320 which holds the data for searching the position information of keys classified into each of the blocks, can be implemented by a main memory 305 or a storage device 306.

The bit-string key sort apparatuses 340a, 340b, . . . 340m sort in parallel the classified keys that are distributed to them. The exemplary configuration of the bit-string key sort apparatus 340a is shown as an example of their configurations. As shown in FIG. 4, the bit string sort is implemented by a data processing apparatus 301a having at least a central processing unit 302a and a cache memory 303a, and using a data storage apparatus 308a. The data storage apparatus 308a, which holds an array 309a and an index key storage area 311a, can be implemented by a main memory 305a or a storage device 306a.

In the example described in FIG. 4, although the main memory 305, the storage device 306, and the communication apparatus 307 of the bit-string key classification/distribution apparatus 300 are connected to the data processing apparatus 301 by a single bus 304, there is no restriction to this connection method. The main memory 305 can be disposed within the data processing apparatus 301, and the search path stack 310 can be implemented as hardware within the central processing unit 302. It will be understood that it is alternatively possible to select appropriate hardware elements in accordance with the usable hardware environment and the size of the index key set, for example, having the index key storage area 311 held in in the storage device 306 and the search path stack 310 and the index key management area 320 held in main memory 305.

Also, although it is not particularly illustrated, a temporary memory area in main memory 305 can of course be used to enable various values obtained during processing or initial values and so on to be used in subsequent processing, depending on the processing to be done. The same also applies to the configuration of the data storage devices and the connection method for the various devices in the bit-string key sort apparatuses 340a, 340b, . . . 340m.

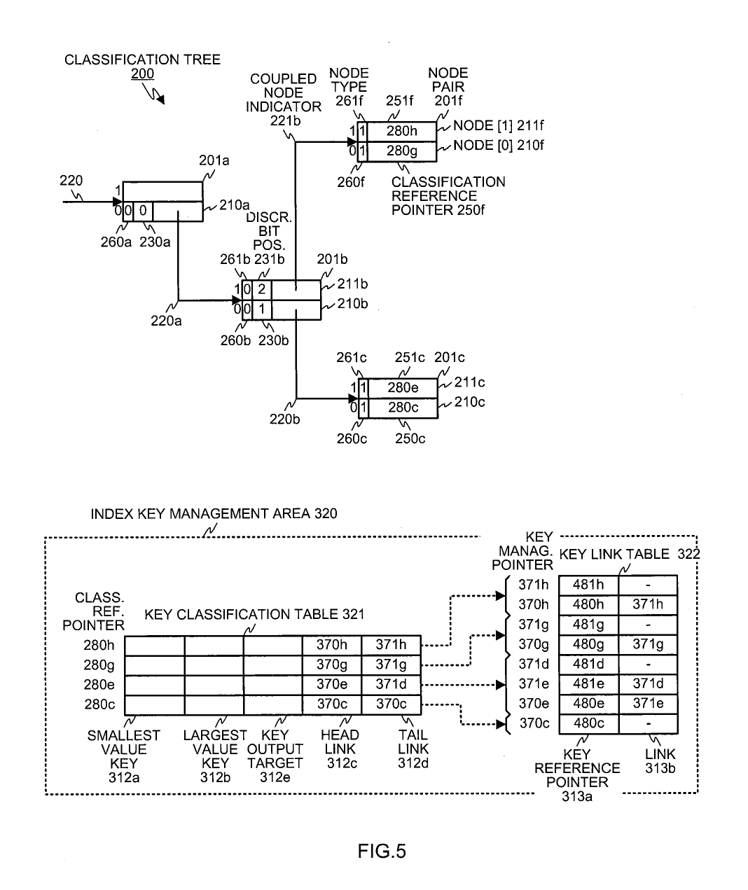

FIG. 5 is a drawing describing conceptually the tree configuration of a classification tree as well as the area for managing index keys, related to a preferred embodiment of this invention.

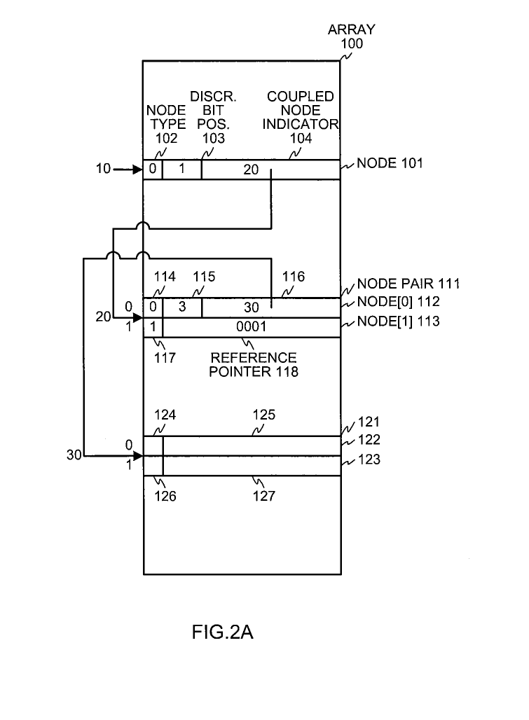

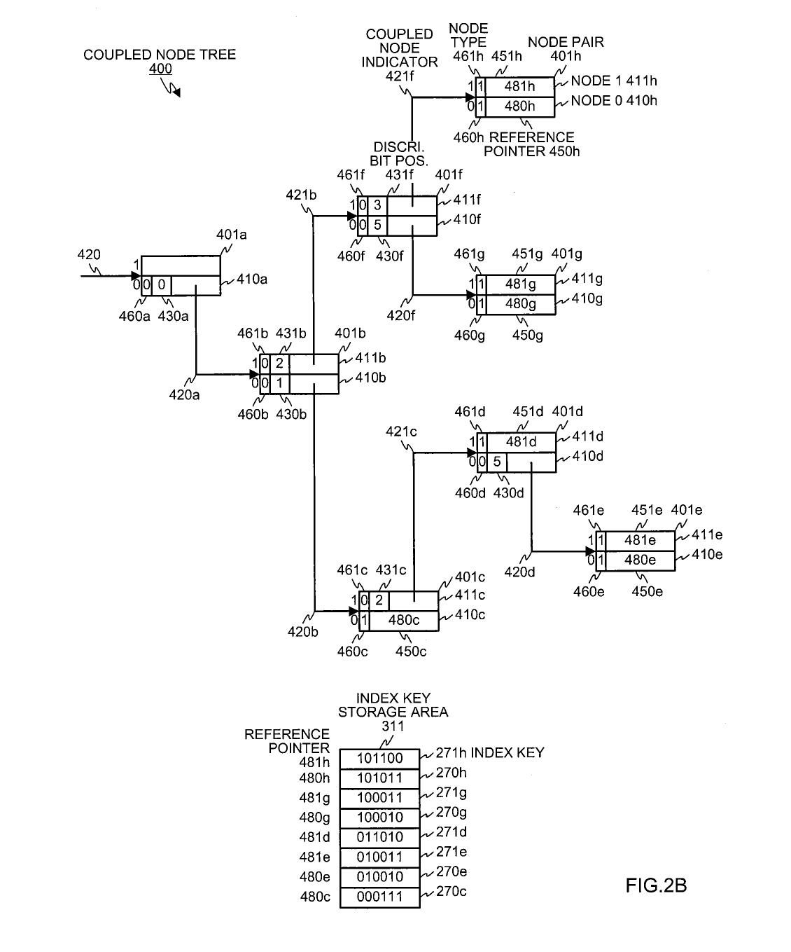

The classification tree 200 in the example shown in FIG. 5 is one wherein the index keys stored in the index key storage area 311 shown in the example in FIG. 2B are to be classified and stored in 4 blocks.

In the index key management area 320 shown in FIG. 5 are stored the key classification table 321 and the key link table 322. An example of the key position search table noted above is configured from the key classification table 321 and the key link table 322, and the classification reference pointer that points to an entry in the key classification table 321 is an example of the above noted key access information. The key management pointers 370h and so on depicted in the key link table 322 in FIG. 5 are associated with the index keys “101011” and so on shown by the reference codes 270h and so on depicted in the index key storage area 311 in FIG. 2B.

Reference code 210a indicates the root node of the classification tree 200 shown in the example in FIG. 5. In the example shown in the drawing, the root node 210a is made to be the primary node of the node pair 201a disposed in array element number 220. As a tree configuration, the node pair 201b is disposed below the root node 210a and at the level below that node pair is disposed the node pair 201c and the node pair 201f.

The example in the drawing shows that the node type 260a for root node 210a is a 0, indicating a branch node and that the discrimination bit position 230a is a 0. The coupled node indicator is 220a, and that is the array element number of the array element holding the primary node 210b of the node pair 201b.

Node pair 201b is configured from node 210b and 211b, and both of their node types 260b and 261b are 0, indicating branch nodes. In the discrimination bit position 230b of node 210b is stored a 1, and in the coupled node indicator for the link target is stored the array element number 220b of the array element holding the primary node 210c of the node pair 201c.

Because a 1 is stored in the node type 260c of node 210c, this node is a leaf node. The leaf node in the classification tree includes the classification reference pointer 250c. In the classification reference pointer 250c is stored a pointer that points to a key classification table entry included in the index key management area 320. The data stored in the classification reference pointer 250c is also called a classification reference pointer and it is indicated with the reference code 280c. In the same way for the other leaf nodes, both the classification reference pointer and the data in the classification reference pointer are expressed by the same words classification reference pointer.

Because a 1 is also stored in the node type 261c of node 211c, which is the other node of the node pair 201c, this node is also a leaf node. In the classification reference pointer 251c for node 211c is stored the classification reference pointer 280e.

In the discrimination bit position 231b for node 211b, which is the other node of the node pair 201b, is stored a 2, and in the coupled node indicator for the link target is stored the array element number 221b of the array element wherein is disposed node [0] 210f which is the primary node of the node pair 201f.

The node types 260f and 261f of node [0] 210f, which is the primary node of the node pair 201f, and of node [1] 211f, which is its pair, are both 1, indicating that both are leaf nodes. In the classification reference pointers 250f and 251f for nodes 210f and 211f are stored classification reference pointers 280g and 280h respectively.

As shown in FIG. 5, the classification tree 200 for classifying the classification keys into 4 blocks includes the root node 210a, which is the branch node at the first level, and the nodes 210b and 211b, which are the branch nodes at the second level, and, as the nodes at the third level, the 4 leaf nodes 210c, 211c, 210f, and 211f that are associated with each block. In the description herein below, the index keys classified into a block associated with a leaf node are said to be index keys included in the leaf node.

Also, the index key management area 320 includes the key classification table 321 and the key link table 322. The storage status of each of the data in index key management area 320 shown in FIG. 5 is that when all the index keys stored in index key storage area 311 shown in FIG. 2B have been classified into 4 blocks.

The key classification table 321 has 4 entries associated with the number of blocks into which the index keys are classified. The starting address of each entry is the classification reference pointers 280c, 280e, 280g, and 280h in the 4 leaf nodes 210c, 211c, 210f, and 211f in the classification tree 200 and each is indicated by that address.

Also, in the example shown in the drawing, the key classification table 321 includes in each entry a smallest value key 312a, a largest value key 312b, a key output target 312e, a head link 312c, and a tail link 312d. In the example shown in the drawing, both the head link 312c and the tail link 312d in the entry pointed to by the classification reference pointer 280c hold the same key management pointer 370c pointing to an entry in the key link table 322. In the head link 312c and the tail link 312d in the entry pointed to by classification reference pointer 280e are stored the key management pointers 370e and 371d, respectively. In the head link 312c and the tail link 312d in the entry pointed to by classification reference pointer 280g are stored the key management pointers 370g and 371g, respectively. In the head link 312c and the tail link 312d in the entry pointed to by classification reference pointer 280h are stored the key management pointers 370h and 371h, respectively.

Notation of the values stored in the smallest value key 312a, the largest value key 312b, and the key output target 312e is omitted. Although the values in the smallest value key 312a and the largest value key 312b are written and updated as the classification tree 200 is being generated, the key output target 312e is written after the generation of the classification tree is completed. Also the key output target can be set to be associated with the blocks classifying the keys to be classified in another table than the key classification table.

The key link table 322 is a table wherein is written the link relationship between index keys that enables the index keys associated with the same leaf node to be traversed successively, and it has entries corresponding to the number of index keys to be classified. For example, if the index key storage area is that shown in FIG. 2B, there are 8 entries. The starting address of each entry in key link table 322 is indicated by the key management pointers 370c, 370e, 371e, 371d, 370g, 371g, 370h, and 371h, and they are associated with the index keys 270c, 270e, 271e, 271d, 270g, 271g, 270h, and 271h respectively.

In the example shown in the drawing, the key link table 322 includes a key reference pointer 313a and a link 313b in each entry. Key reference pointer 313a points to the index key storage area associated with the key management pointer pointed to by that entry. Thus, if the index storage area is that shown in FIG. 2B, the reference pointers 480c, 480e, 481e, 481d, 480g, 481g, 480h, and 481h are stored in the key reference pointer 313a in the key link table 322 entries pointed to by the key management pointers 370c, 370e, 371e, 371d, 370g, 371g, 370h, and 371h.

The key management pointer associated with another index key classified into the same block as the index key associated with current key management pointer is stored in link 313b in the key link table 322 entry pointed to by the current key management pointer. In the example shown in FIG. 5, the index key 270h associated with the key management pointer 370h and the index key 271h associated with key management pointer 371h are classified into the block associated with the classification reference pointer 280h. The key management pointer 371h is stored in link 313b of the key link table 322 entry pointed to by the key management pointer 370h, which is the head link 312c of that block. Key management pointer 371h, which is associated with index key 271h, is stored in the tail link in key classification table 321, and because index key 271h is the tail index key in the block, nothing is stored in link 313b of the key link table 322 entry pointed to by key management pointer 371h.

In the same way, the index key 270g associated with the key management pointer 370g and the index key 271g associated with key management pointer 371g are classified into the block associated with the classification reference pointer 280g. The key management pointer 371g is stored in link 313b of the key link table 322 entry pointed to by the key management pointer 370g associated with the index key 270g, which is the head link 312c of that block. The key management pointer 371g, which is associated with index key 271g, is stored in the tail link in key classification table 321, and because index key 271g is the tail index key in the block, nothing is stored in link 313b pointed to by key management pointer 371g.

The index key 270e associated with the key management pointer 370e, and the index key 271e associated with key management pointer 371e, and the index key 271d associated with the key management pointer 371d are classified into the block associated with the classification reference pointer 280e. The key management pointer 371e is stored in link 313b of the key link table 322 entry pointed to by the key management pointer 370e associated with the index key 270e, which is the head link 312c of that block. The key management pointer 371d is stored in link 313b of the key link table 322 entry pointed to by the key management pointer 371e. Then key management pointer 371d, which is associated with index key 271d, is stored in the tail link in key classification table 321, and because index key 271d is the tail index key in the block, nothing is stored in link 313b of the key link table 322 entry pointed to by key management pointer 371d.

Also, the index key 270c associated with key management pointer 370c is classified into the block associated with the classification reference pointer 280c. Because the key management pointer 370c associated with the index key 270c is stored in both the head link 312c and tail link 312d in the key classification table 321 entry pointed to by the classification reference pointer 280c, the index keys classified into the block associated with classification reference pointer 280c consist of only index key 270c. Thus, nothing is stored in link 313b of the key link table 322 entry pointed to by the key management pointer 370c.

Also, in the description hereinbelow, associating index keys with a leaf node is sometimes said to be linking index keys into the key link table for the leaf node. Also the leaf node for which index keys have been associated may at times be said to the leaf node linking those index keys.

The index keys in a block associated with a classification reference pointer in the above noted key classification table 321 can all be extracted in the following way. First, the head link 312c pointed to by the classification reference pointer is made to be the key management pointer for key link table 322 and the key reference pointer 313a is read out, and the index key pointed to by the key reference pointer 313a is extracted from the index key storage area. Next the operation of making the link 313b to be the key management pointer for key link table 322, and reading out the key reference pointer 313a, and extracting the index key pointed to by the key reference pointer 313a from the index key storage area is repeated until link 313b coincides with the tail link 312d in the key classification table 321.

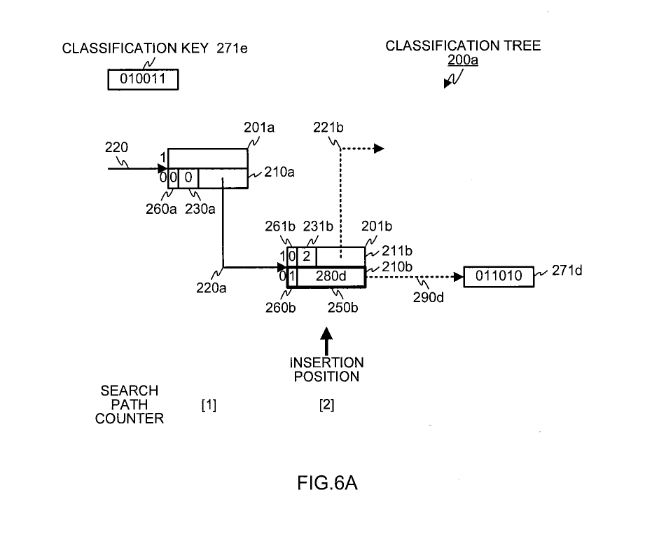

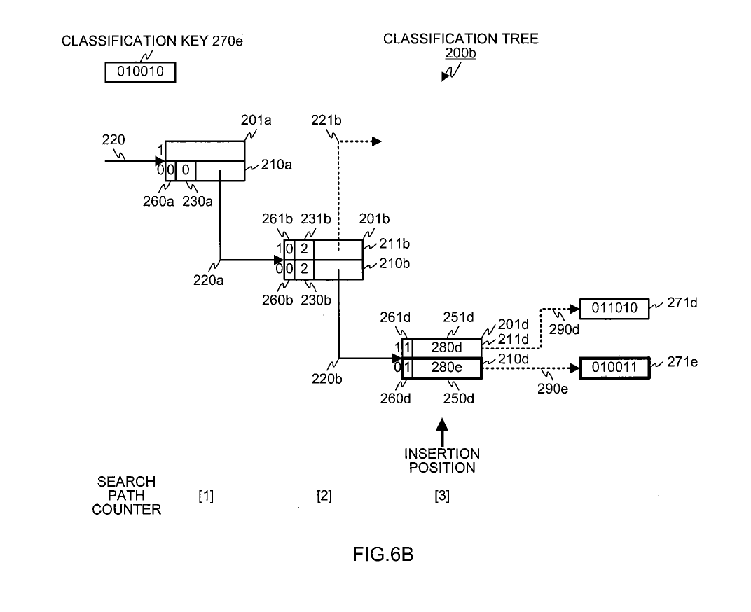

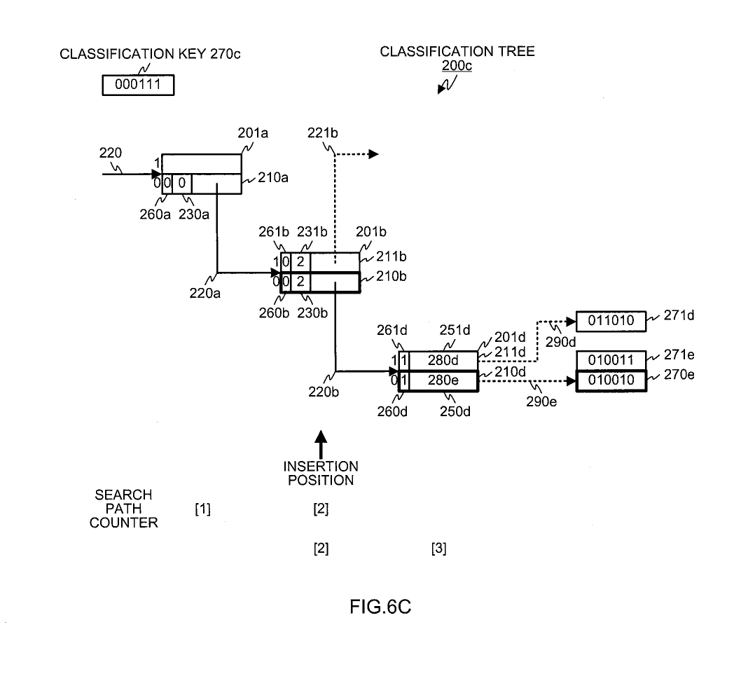

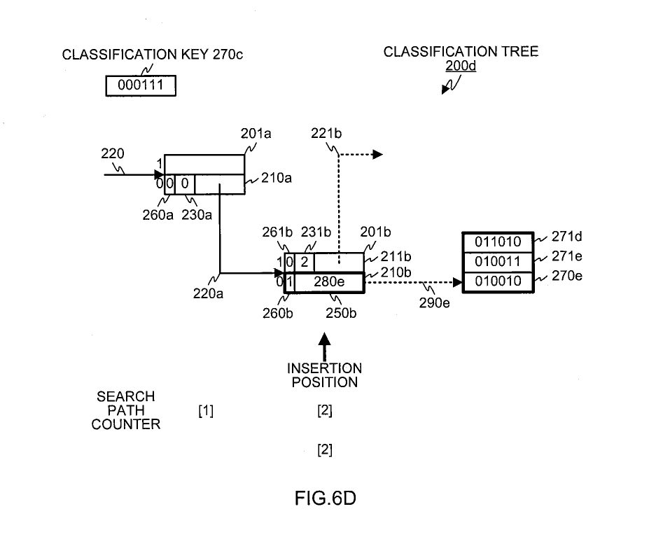

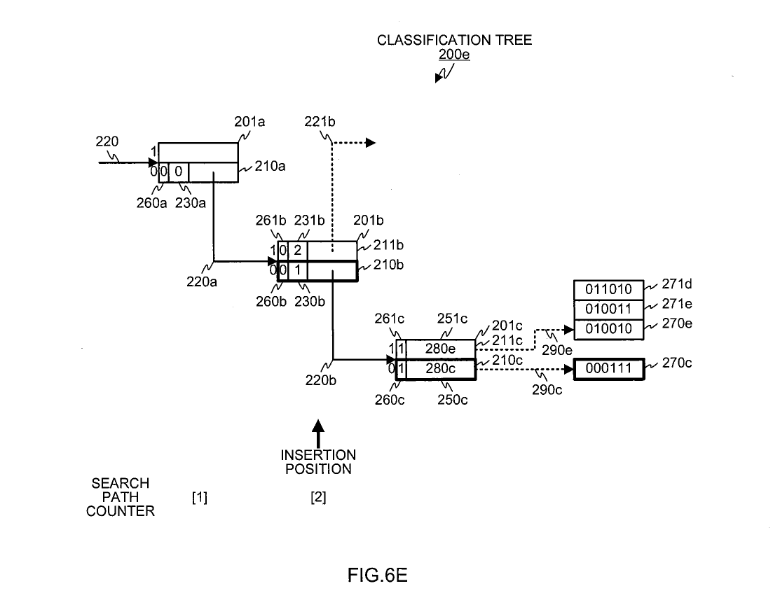

Next, an overview of the processing to generate classification tree 200 is described, referencing FIG. 6A to FIG. 6E. Description of the parts in classification tree 200 at node 211b and below is omitted. Also, the index key 271d “011010” is taken to be already classified into the block associated with leaf node 210b, in other words, it is taken to be linked with the key link table for leaf node 210b. Also, in the description below, the index key read out from the index key storage area and subjected to classification processing may at times be called the classification key. Also, the classification of classification keys by means of the classification tree into blocks associated with leaf nodes, in other words, linking them to the key link table for a leaf node, may at times be called inserting a classification key into the classification tree. Because the maximum number of levels for the classification tree is restricted, when a classification key is inserted into the classification tree, besides inserting in the classification tree the node pair that includes the leaf node linking to the classification key, there are cases wherein the classification key is linked to an existing leaf node and cases wherein the parent node, which is the node immediately above the node pair comprising the existing leaf node, is made to be a leaf node and the classification key is linked to the key link table for that leaf node.

FIG. 6A is a drawing describing the status of the classification tree 200a before the classification key “010011” is inserted. The classification tree 200a shown in FIG. 6A is the tree wherein the node 210b in the classification tree 200 shown in FIG. 5 is made to be a leaf node, and the classification reference pointer 280d is stored in that classification reference pointer 250b. Also notation of the nodes below node 211b is omitted. Omission of notation of those lower nodes also applies to FIG. 6B to FIG. 6E.

As shown by the dotted-line arrow 290d in FIG. 6A, index key 271d “011010” stored in index key storage area 311 is associated with leaf node 210b by means of the classification reference pointer 280d via the index key management area 320. Saying it in another way, index key 271d is linked to the key link table for leaf node 210b.

FIG. 6A depicts the classification key 271e “010011” as the classification key to be inserted and its insertion position.

Also the count value for the search path counter is depicted. The count value in the search path counter is used, when a classification key is to be inserted in the classification tree, to enable the determination whether the restriction on the number of levels in the classification tree is satisfied and whether the node pair that includes the leaf node that links to the classification key can be inserted into the classification tree. The count value in the search path counter is counted up, for example, from an initial value 0, and, as shown in FIG. 6A, the value 1 is taken to be obtained for the root node. Also it is clear that by making the initial value to be the maximum number of levels in the classification tree and counting down from that value and making the determination of whether the count value is 0, a determination can be made as to whether the restriction on the number of levels in the classification tree is satisfied and whether the node pair that includes the leaf node that links to the classification key can be inserted into the classification tree.

In the example in FIG. 6A, because the value in the discrimination bit position 260a stored in root node 210a is 0 and the bit value at the 0th bit in the classification key 271e “010011” to be inserted is 0, the leaf node 210b is obtained as a result of a search using the classification key 271e to be inserted. The value of the search path counter becomes the 2 in leaf node 210b. Also, by means of the relative position relationship between the difference bit position, which is the position of the first differing bit value seen from the highest bit positions between the classification key 271e “010011” and the index key 271d “011010” linked to the key link table for leaf node 210b, and the discrimination bit position in branch node 210a, the classification key 271e is inserted below leaf node 210b. Thus the insertion position for classification key 271e is the node 210b as shown in the drawing. Because the maximum number of levels for the classification tree is 3, and the count value for the search path counter is 2, the restriction on the number of levels is satisfied, and so the classification key 271e to be inserted and the node pair that includes the linking leaf node can be inserted below node 210b.

FIG. 6B is a drawing describing the classification tree 200b with a status after the classification key 271e “010011” is inserted and before the classification key 270e “010010” is inserted. The node pair 201d that includes the leaf node to link to the classification key 271e “010011” is inserted below node 210b. The node 210b which is a leaf node in the classification tree 200a has become a branch node, and the difference bit position 2 between the index key 271d and the classification key 271e is stored in discrimination bit position. The coupled node indicator 220b for node 210b is the array element number of the array element in which is disposed the primary node 210d of the inserted node pair 201d.

Because the index key 271d is larger than the classification key 271e, the leaf node linking to the classification key 271d becomes node 211d, which is the node [1] in node pair 201d. As shown in FIG. 6B, the contents of node 210b shown in FIG. 6A have been copied to node 211d in FIG. 6B.

The node 210d, which is the node [0] in node pair 201d, has become a leaf node linking to classification key 271e. The classification reference pointer 280e is stored in its classification reference pointer 250d. Then, as shown by the dotted-line arrow 290e, index key 271e “010011” stored in index key storage area 311 is associated with leaf node 210d by means of the classification reference pointer 280e via the index key management area 320. In other words, classification key 271e “010011” is classified into leaf node 210d.

In addition to the classification tree 200b, FIG. 6B shows the classification key 270e “010010” as the classification key next to be inserted and the node 210d as the insertion position for the classification key 270e. Also, the count value for the search path counter at leaf node 210d shows a 3, which is the maximum number of levels. Thus, due to the restriction on number of levels, a node pair that includes a leaf node linking to classification key 270e cannot be inserted below node 210d.

FIG. 6C is a drawing describing the classification tree 200c with a status after the classification key 270e “010010” is inserted and before the classification key 270c “000111” is inserted. As is noted above, because a node pair that includes a leaf node linking to classification key 270e cannot be inserted below node 210d, the classification key 270e “010010” in addition to index key 271e “010011” is linked to the key link table for the leaf node 210d at the insertion position shown in FIG. 6B, as shown by the dotted-line arrow 290e in FIG. 6C. Although details of this processing are described later, it takes place by means of modifying the key classification table 321 and the key link table 322 in the index key management area 320.

In addition to the classification tree 200c, FIG. 6C shows the classification key 270c “000111” as the classification key next to be inserted and the node 210b as the insertion position for the classification key 270c. Also, the count value for the search path counter is shown in 2 rows. Each of the count values shown in the upper row is the count when the insertion position is obtained, and it is counted up from the count value 1 associated with the root node 210a at the first level to the count value 2 associated with node 210b which is the insertion position at the second level. Each of the count values shown in the lower row is the count when, making the node 210b, which is the insertion position, to be the search start node, a leaf node at levels lower than node 210b is successively searched for and the number of levels of the leaf node is obtained, and it is counted up from the count value 2 associated with search start node 210b to the count value 3 associated with leaf node 210d at the third level. Then when a node pair including a leaf node linking to classification key 270c is inserted below node 210b the number of levels at leaf node 210d become 4. Thus because this exceeds the restriction on the number of levels, a node pair including a leaf node linking to classification key 270c cannot be inserted below node 210b.

FIG. 6D is a drawing describing the classification tree 200d with the status wherein index keys that have been linked to the key link table for leaf nodes below the insertion position where a node pair is to be inserted are linked to the key link table for a leaf node at the insertion position. As is noted above, a node pair cannot be inserted below node 210b, which is the insertion position in the classification tree 200c shown in FIG. 6C. And so, in accordance with this invention, by making the parent node of the node pair comprising 2 leaf nodes (child nodes) into a leaf node and linking to the key link table of the leaf node that is made to be the parent node the index keys linked to the key link table for the 2 child nodes (Hereinbelow this may be called consolidating the leaf nodes below the insertion position or consolidating leaf nodes) the number of levels in the classification tree can be reduced and a node pair can be inserted that includes a leaf node linking to the classification key to be inserted.

As shown in FIG. 6D, the node 210b in classification tree 200d is one wherein the contents of the leaf node 210d in the classification tree 200c shown in FIG. 6C have been written into the node 210b, which is the branch node above the node pair 201d comprising leaf node 210d and leaf node 211d. Then, as shown by the dotted-line arrow 290e in FIG. 6D, the index key 270e “010010”, the index key 271e “010011”, and the index key 271d “011010” are linked to the key link table entries for the leaf node 210b shown in FIG. 6D.

In addition to the classification tree 200d, FIG. 6D shows the classification key 270c “000111” as the classification key next to be inserted and the node 210b as the insertion position for the classification key 270c. Also, the count value for the search path counter at the lower row at leaf node 210b has been reduced by 1 and shows a 2. Thus the number of levels in classification tree 200d has been reduced by 1 and a node pair including a leaf node linking to classification key 270c can be inserted below node 210b in classification tree 200d.

FIG. 6E is a drawing describing the status of the classification tree 200e after the leaf nodes below the insertion position are consolidated and the classification key 270c “000111” is inserted in classification tree 200d. The node pair 201c including the leaf node linking to the classification key 270c “000111” is inserted below node 210b. The node 210b, which is a leaf node in classification tree 200d, becomes a branch node, and the value 1, which is the difference bit position between the classification key 270c and the index key 270e, is stored in its discrimination bit position. The coupled node indicator 220b for node 210b is the array element number for the array element wherein is disposed the primary node 210c for the inserted node pair 201c.

Because the classification key 270c is smaller than the index key 270e, the leaf node linking to classification key 270c becomes node 210c which is the node [0] in the node pair 201c. The classification reference pointer 280c is stored in its classification reference pointer 250c. Then, as shown by the dotted-line arrow 290c, index key 270c “000111” stored in index key storage area 311 is associated with leaf node 210c by means of the classification reference pointer 280c via the index key management area 320. In other words, classification key 270c “000111” is classified into leaf node 210c.

Also, as shown in FIG. 6E, the contents of node 210b shown in FIG. 6D have been copied to node 211c in FIG. 6E. By means of the flow described above, the classification tree 200 shown in FIG. 5 is generated.

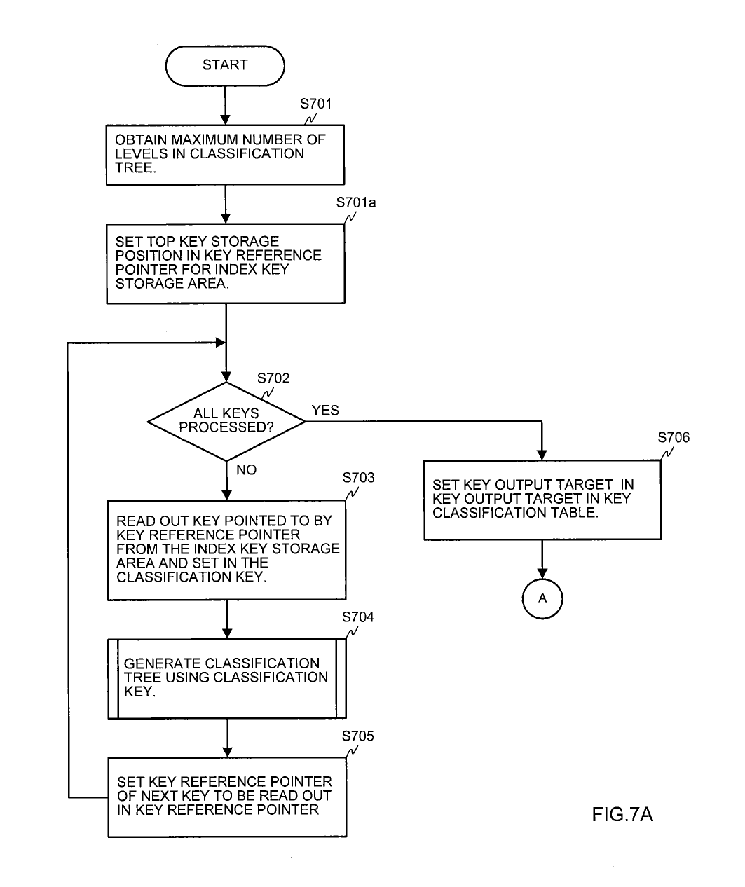

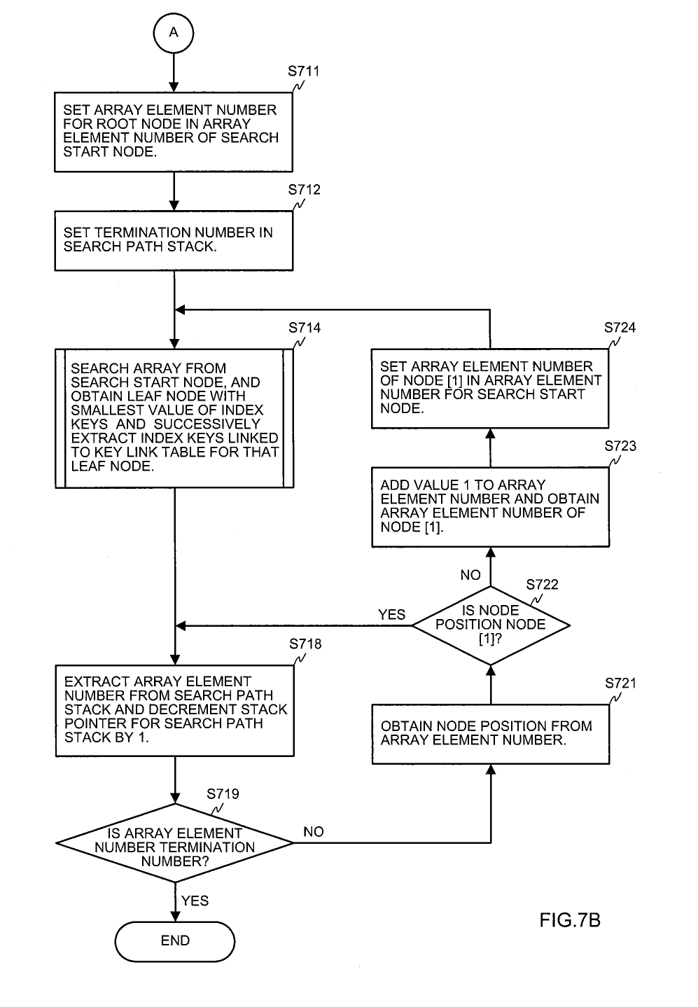

Next, referencing FIG. 7A and FIG. 7B, an overview is described of the overall processing to classify index keys and to output the classified keys to an output target in a preferred embodiment of this invention.

FIG. 7A is a drawing showing an example of the processing flow in classification processing in a preferred embodiment of this invention. Classification processing generates a classification tree using the classification keys and classifies them by writing data into the index key management area and associating the index keys to be classified with leaf nodes in the classification tree. Also, in the description below, generating a classification tree using the classification keys and writing data into the index key management area may be simply called generating a classification tree.

As shown in FIG. 7A, first, in step S701, the maximum number of levels in the classification tree is obtained. This maximum number of levels can be obtained directly or it can be computed from the number of blocks for classifying the keys to be classified. As is noted above, if the number of blocks is 8, in order to make the maximum number of levels to be 4, the exponent for the smallest power of 2 value that is not smaller than the number of blocks has 1 added to it and that value can be made the maximum number of levels.

Next in step S701a, the top key storage position in the index key storage area is set in the key reference pointer for the index key storage area. Here the key reference pointer for the index key storage area is one of the temporary memory areas not especially illustrated but used to enable various values obtained during processing to be used in subsequent processing, noted above.

Next in step S702, a determination is made whether all the keys to be classified have been processed, and if they are finished, processing proceeds via step S706 to step S711 and thereafter shown in FIG. 7B, and if they are not all finished, processing proceeds to step S703.

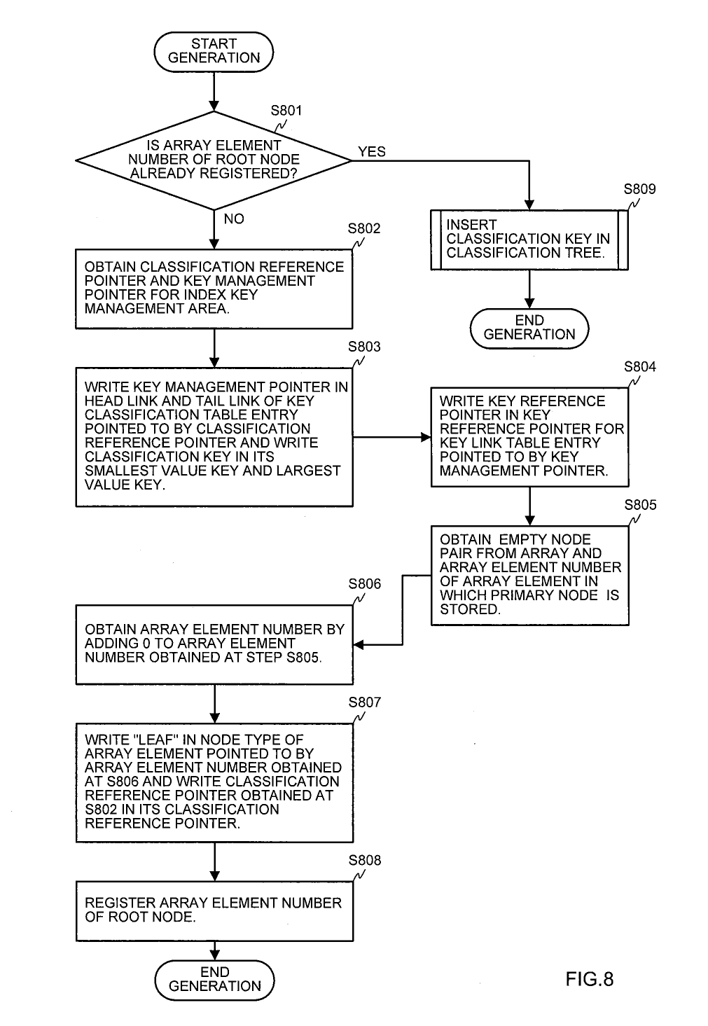

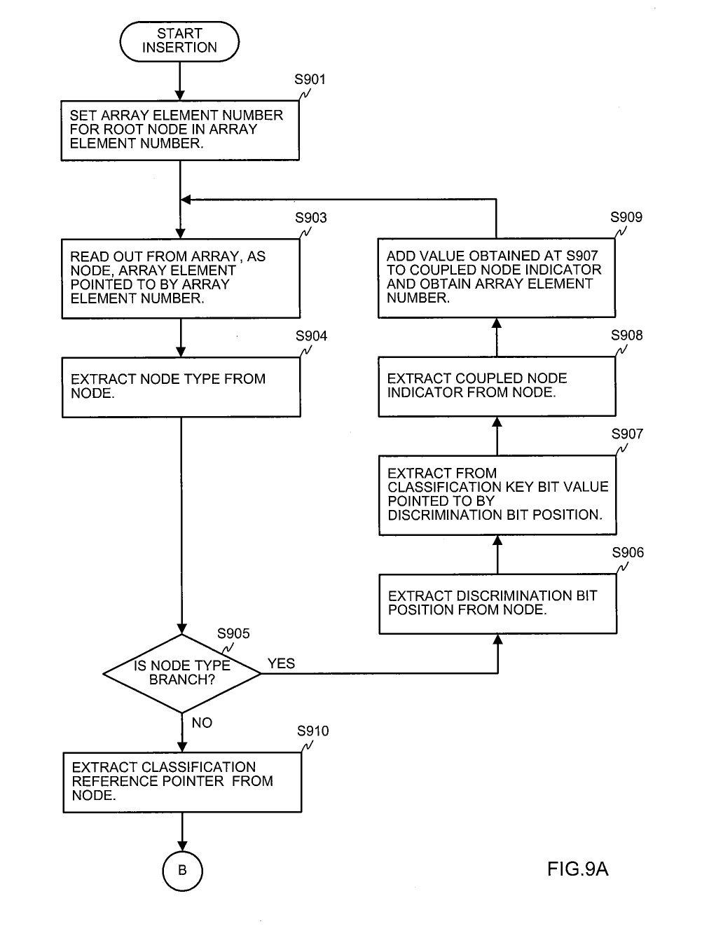

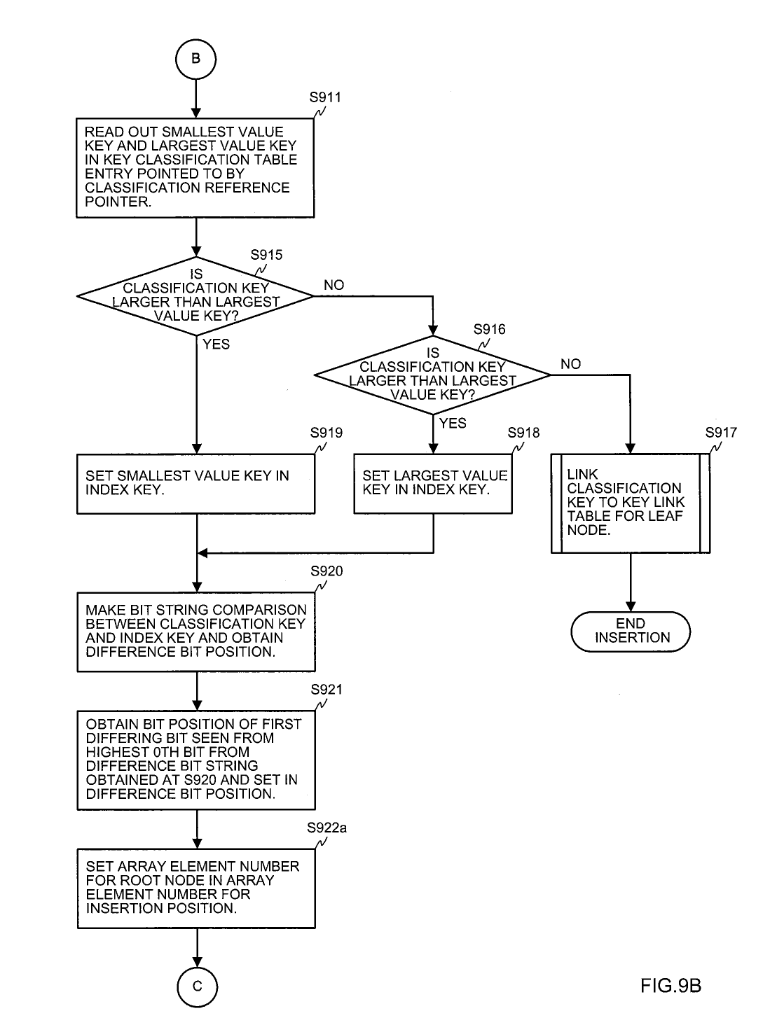

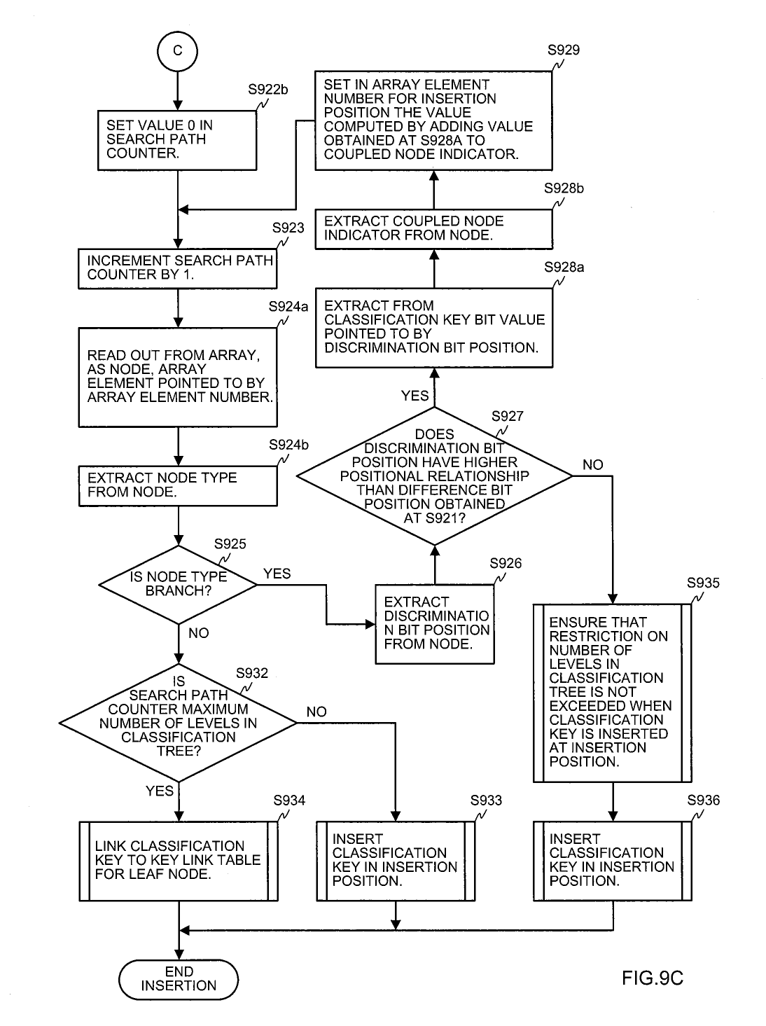

At step S703, the key pointed to by the key reference pointer is read out from the index key storage area and is set in the classification key. Then in step S704, the classification tree is generated using the classification key. Details of the classification tree generation processing in step S704 is explained later referencing FIG. 8 and FIG. 9A to FIG. 9C.

Next in step S705, the storage position of the next key stored in the index key storage area is set in the key reference pointer for the index key storage area and a return is made to step S702. The processing loop of step S702 to step S705 is repeated until the determination at step S702 is that all of the keys have been processed, and when the determination at step S702 is that all of the keys have been processed, classification processing is terminated and in step S706, the output target for the keys is set in the key output target in the key classification table, and processing proceeds to the distribution processing in step S711 and thereafter shown in FIG. 7B.

FIG. 7B is a drawing showing an example of the processing flow in distribution processing in a preferred embodiment of this invention. Distribution processing is the processing to read out, by means of data in the index key management area written during classification processing, the classification keys classified into each block and to output them to the output target.

As shown in FIG. 7B, first, in step S711, the array element number for the root node of the classification tree is set in the array element number of the search start node. Next in step S712, a termination number is stored, as the array element number first stored, in the search path stack holding the array element numbers of the array elements in which are disposed the nodes traversed during search processing. It is sufficient that this termination number can be distinguished from the array element numbers of the array elements in which are disposed the nodes traversed during search processing.

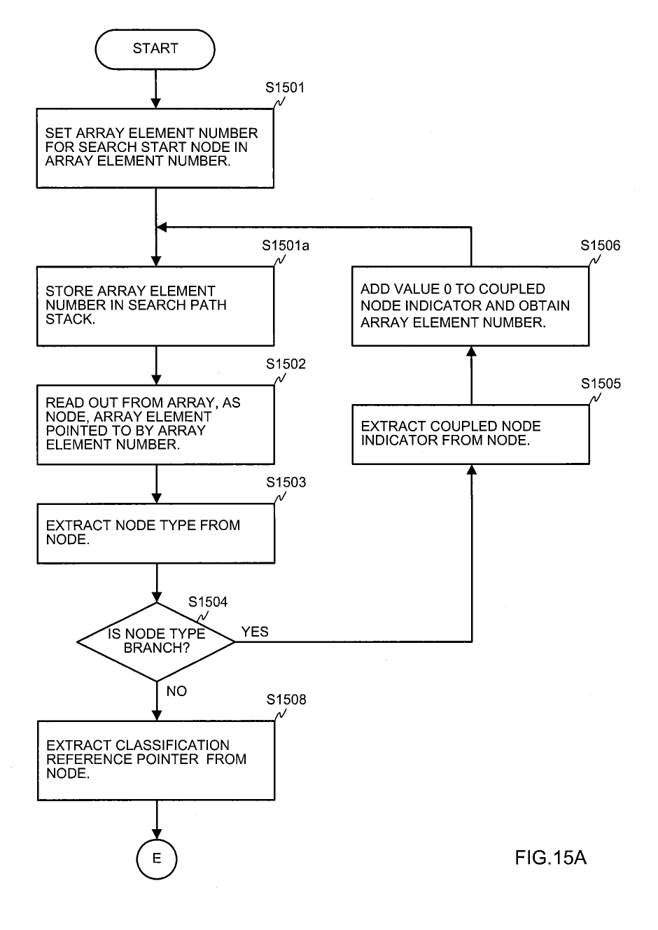

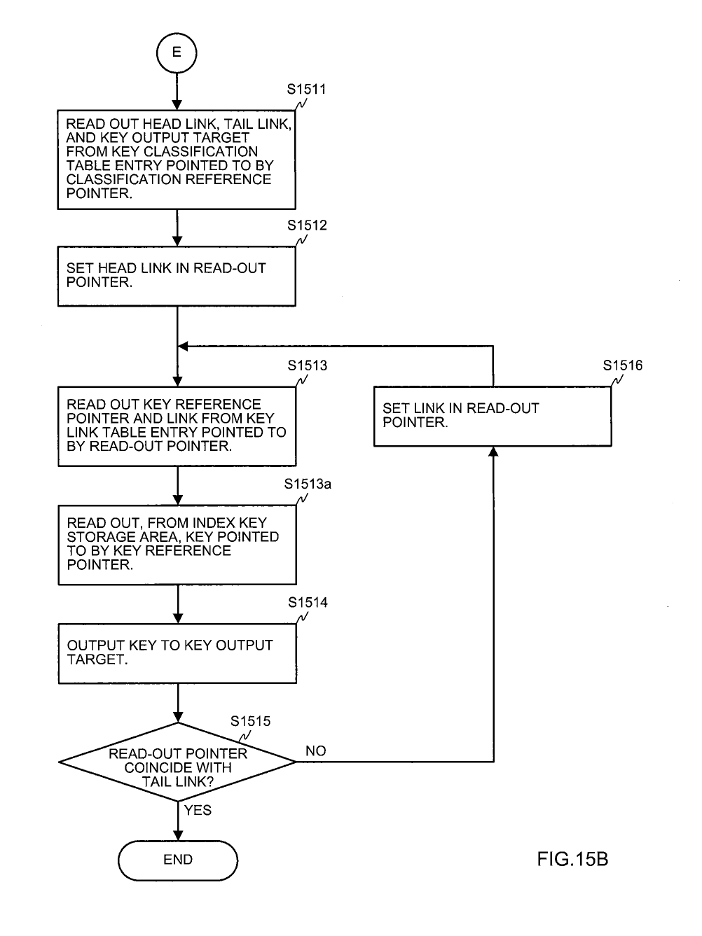

Next, in step S714, the array is searched from the search start node, and the leaf node with the smallest value of the index keys is obtained, and the index keys linked to the key link table for that leaf node are successively extracted. Details of the processing in step S714 are described later referencing FIG. 15A and FIG. 15B.

Next, at step S718, an array element number is extracted from the search path stack, the stack pointer for the search path stack is decremented by 1, and processing proceeds to step S719. At step S719, a determination is made whether the array element number extracted at step S718 is the termination number. If the result of the determination is that it is the termination number, processing is terminated, and if it is not the termination number, processing proceeds to step S721.

At step S721, the node position (node [0] or node [1]) for whichever of the array elements of the node pair wherein is stored the node for that array element number is obtained from the array element number extracted at step S718. For example because a node [0] would be stored in an array element in the array with an even array element number, the node position can be obtained from the array element number.

Then, at step S722, a determination is made whether the node position obtained at step S721 is a node [1]. If the determination in step S722 is that it is the node [1], a return is made to step S718.

When the determination in step S722 is that it is a node [0], processing proceeds to step S723, wherein a 1 is added to the array element number, and the array element number of the node [1] that is a pair to that node is obtained. Then, at step S724, the array element number for the node [1] obtained at step S723 is set in the array element number for the search start node, and a return is made to step S714.

The processing loop of the above noted steps S714 to S724 is repeated while decrementing the stack pointer for the search path stack by 1 at step S718, until the determination at step S719 is that the array element number extracted from the search path stack is the termination number. If the array element number extracted from the search path stack is the termination number, processing is terminated because processing is completed for all the leaf nodes in the classification tree.

The processing to extract the classification keys stored in the classification tree shown in the above noted FIG. 7B is similar to the processing to extract index keys from the coupled-node tree in ascending sequence disclosed in drawing number 10 in the previously noted patent reference 4 (Hereinbelow this may be called the processing in the previous invention). Although the leaf nodes are obtained in ascending sequence by the flow shown in the example in FIG. 7B, it will be clear to one skilled in the art that the keys classified in each block can be extracted even by obtaining them in descending order. Also, whereas the index key linked to a leaf node is 1 in the previous invention, because in this invention there may be a plurality of index keys linked to the key link table for the leaf node, this invention is intrinsically different in the point that the index keys linked to the key link table entries for a leaf node are successively extracted in step S714.

Next, details of the processing in step S704 shown in FIG. 7A to generate a classification tree using a classification key is described referencing FIG. 8 and FIG. 9A to FIG. 9C. FIG. 8 is a drawing describing an example of the overall processing flow for generating a classification tree by means of a classification key in a preferred embodiment of this invention. Presupposing the processing shown in FIG. 8, in step S703 shown in FIG. 7A, the classification key is set in a temporary storage area.

As shown in FIG. 8, first, in step S801, a determination is made whether the array element number of the root node has been registered. If the array element number of the root node has not been registered, processing proceeds to step S802 and thereafter, wherein a new classification tree is generated wherein the leaf node linking to the classification key set in the temporary storage area noted above is made the root node.

At step S802, the classification reference pointer and the key management pointer for the index key management area are obtained. The classification reference pointer and key management pointer obtained here are set for the index key management area 320 in data storage apparatus 308 and are obtained by determining the addresses of the entries to be used first in the key classification table and key link table.

Next, in step S803, the key management pointer is written in the head link and tail link of the key classification table entry pointed to by the classification reference pointer and the classification key is written in the smallest value key and largest value key, and in step S804, the key reference pointer used to read out the key at step S703 in FIG. 7A is written in the key reference pointer for the key link table entry pointed to by the key management pointer. For example, when the classification key first processed is made to be the classification key 271d shown in the FIG. 2B, and the classification pointer pointing to the first entry to be used in the key classification table 321 shown in FIG. 5 is made to be 280d, and the key management pointer pointing to the first entry to be used in the key link table 322 is made to be 371d, then the classification key 271d is written in the smallest value key 312a and the largest value key 312b of the key classification table 321 entry pointed to by classification pointer 280d and the key management pointer 371 is written in the head link 312c and the tail link 312d respectively, and the reference pointer 481d shown in FIG. 2B is written in the key reference pointer 313a in the key link table 322 entry pointed to by key management pointer 371d.

Next, in step S805, an empty node pair is obtained from the array, and the array element number of the array element that is intended to be the primary node in that node pair is obtained, and in step S806, a 0 is added to the array element number obtained at step S805 and an array element number is obtained. (This number is actually the same as the array element number obtained at step S805.)

Furthermore, in step S807, in the array element with the array element number obtained at step S806, a 1 (leaf node) is written in the node type of the root node that is to be generated and the classification reference pointer obtained at step S802 is written in the classification reference pointer, and at step S808, the array element number of the root node obtained at step S805 is registered and processing is terminated.

When the above noted classification key first to be processed is made to be key 271d, the leaf node 210b shown in FIG. 6A becomes the root node first to be generated.

Also, although the entry pointed to by classification reference pointer 280d in the key classification table shown in FIG. 5 is not depicted, in the process of successively inserting classification keys, there are cases where the key classification table entries used at the beginning are merged with other entries and become unused.

When the determination in step S801 is that the array element number of the root node has been registered, processing proceeds to step S809, wherein an updated classification tree is generated by inserting the classification key in the classification tree for which the root node has already been registered, and processing is terminated. Details of the processing in step S809 is described next referencing FIG. 9A to FIG. 9C.

FIG. 9A is a drawing showing an example of the processing flow for the initial stage of the processing for inserting a classification key in the classification tree in a preferred embodiment of this invention. This first stage of processing is the processing to make the root node of the classification tree to be the search start node and the search processing to obtain a leaf node using the classification key as the search key. As is described above referencing FIG. 6A, the count value in the search path counter is counted up for the node levels in the search path traversed up to the leaf node.

As shown in FIG. 9A, first, at step S901, the array element number of the root node is set in the array element number, and processing proceeds to step S903.

At step S903, the array element pointed to by the array element number is read out from the array as a node, and at step S904, the node type is extracted from the node, and at step S905, a determination is made whether the node type is a branch node.

If, in the determination in step S905, the determination is that the read-out node is a branch node, processing proceeds to step S906, wherein the discrimination bit position is extracted from the node, and furthermore, at step S907, the bit value corresponding to the extracted discrimination bit position is extracted from the classification key. Then, in step S908, the coupled node indicator is extracted from the node. Also in step S909, the bit value extracted from the classification key is added to the coupled node indicator, an updated array element number is obtained, and a return is made to step S902.

Thereafter, the processing loop of step S903 to step S909 is repeated until the determination in step S905 is that the node is a leaf node and processing proceeds to step S910. At step S910, the classification reference pointer is extracted from the leaf node, and processing proceeds to step S911 shown in FIG. 9B.

FIG. 9B is a drawing showing an example of the processing flow for the middle stage of the processing for inserting a classification key in the classification tree in a preferred embodiment of this invention. This middle stage of processing includes a comparison of the value of the classification key with the values of the keys linked to the key link table for the leaf node obtained in the initial stage of processing, and preparation for the processing to obtain the insertion position of a node pair that includes the leaf node for linking to the classification key.

As shown in FIG. 9B, first, in step S911, the smallest value key and the largest value key for the key classification table entry pointed to by the classification reference pointer extracted at step S910 in FIG. 9A are read out. Next, proceeding to step 915, a determination is made whether the classification key is smaller than the smallest value key.

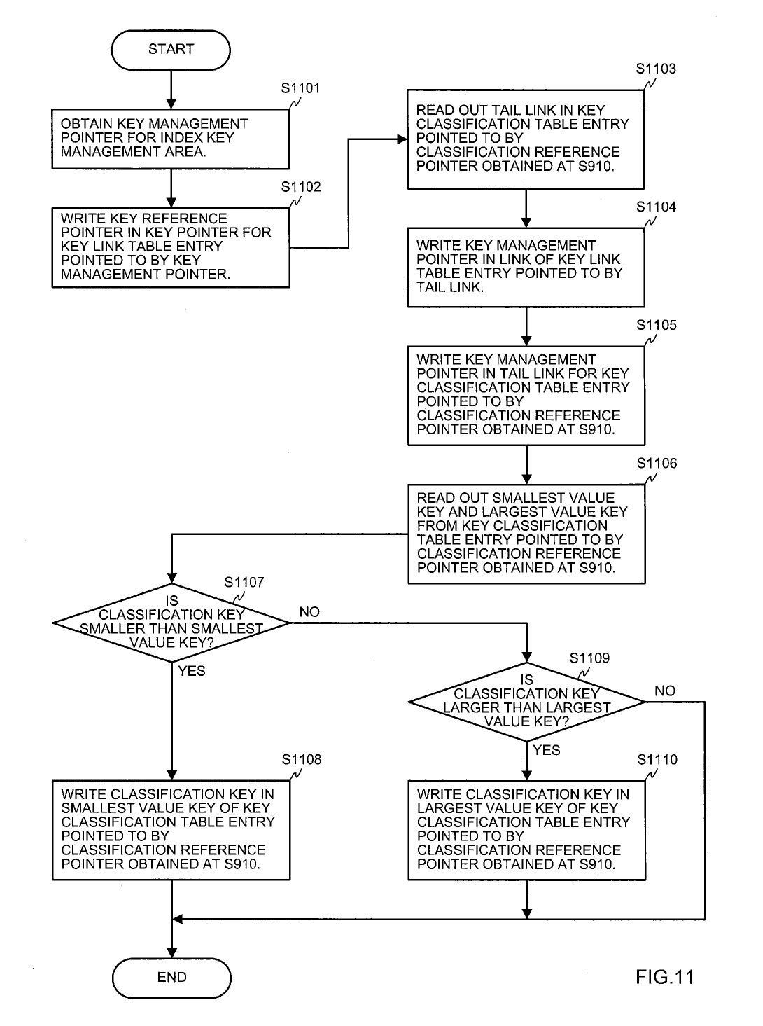

If the classification key is not smaller than the smallest value key, in step S916, a further determination is made whether the classification key is larger than the largest value key. If the determination in step S916 is that the classification key is not larger than the largest value key, in other words, the value of the classification key is determined to be between the values of the smallest value key and the largest value key, then at step S917, the classification key is linked to the key link table for the leaf node, and insertion processing is terminated. Details of the processing in step S917 are described later referencing FIG. 11.

Conversely, when the determination in step S916 is that the classification key is larger than the largest value key, processing proceeds to step S918 wherein the largest value is set in the index key and processing proceeds to step S920.

Also, when the determination in step S915 noted above is that classification key is smaller than the smallest value key, in step S919, the smallest value is set in the index key and processing proceeds to step S920.

In step S920, a bit string comparison is performed, for example with an exclusive OR, between the classification key and the index key set at step S918 or step S919, and a difference bit string is obtained. Next, in step S921, the bit position (difference bit position) of the first differing bit seen from the highest 0th bit is obtained from the difference bit string obtained at step S920. This processing can be done, for example, by inputting the difference bit string to a CPU that has a priority encoder and thus obtaining the differing bit position. The bit position of the first differing bit can also be obtained by having software perform the same kind of processing as a priority encoder.

Next, in step S922a, the array element number of the root node is set in the array element number for the insertion position, and processing proceeds to step S922b shown in FIG. 9C.

FIG. 9C is a drawing showing an example of the processing flow for the last stage of the processing for inserting a classification key in the classification tree in a preferred embodiment of this invention. The processing in this last stage links the classification key to the key link table for the leaf node, based on the preparation done in the middle stage shown in FIG. 9B.

As shown in FIG. 9C first, in step S922b, the search path counter is initialized to 0, and processing proceeds to step S923.

At step S923, the count value in the search path counter is incremented by 1. Next, in step S924a, the array element pointed to by the array element number of the insertion position is read out from the array as a node, and in step S924b, the node type is extracted from the node, and processing proceeds to step S925.

At step S925, a determination is made whether the node type extracted at step S924b is a branch node. If the node type does not indicate a branch node, in other words, it indicates a leaf node, then processing proceeds to step S932.

Conversely, if the node type indicates a branch node, processing proceeds to step S926, wherein the discrimination bit position is extracted from the node, and in step S927, a determination is made whether the discrimination bit position has a positional relationship higher than the difference bit position obtained at step S921. If the discrimination bit position is not higher than the difference bit position, processing proceeds to step S935.

Conversely, if the discrimination bit position is higher than the difference bit position, processing proceeds to step S928a. At step S928a, the bit value pointed to by the discrimination bit position is extracted from the classification key, and at step S928b the coupled node indicator is extracted from the node. Then, in step S929, the value obtained by adding the value obtained at step S928a to that coupled node indicator is set in the array element number of the insertion position, and a return is made to step S923.

The processing loop of the above noted step S923 to step S929 repeats a search from the root node until the determination at step S925 is that the node type is a leaf node or the determination at step S927 is that the discrimination bit position is not higher than the difference bit position. The array element number of the insertion position set at step S929 immediately before the processing loop is escaped at step S925 or step S927 or, if the root node is a leaf node, the array element number of the insertion position set at step S922a indicates the insertion position for a node pair that includes the leaf node linking to the classification key.

The processing loop of the above noted step S923 to step S929 traverses the branch nodes in the search path and, the same as for the search processing shown in FIG. 9A, once again traverses the search path from the root node, which is the search start node, in the direction of the leaf node in order to determine the relative position relationship between the discrimination bit positions in the branch nodes and the difference bit position between the classification key and the index key.

When the determination at the above noted step S925 is that the node type extracted at step S924b indicates a leaf node, processing proceeds to step S932, wherein a determination is made whether the search path counter shows the largest value, which is the value of the maximum number of levels in the classification tree.

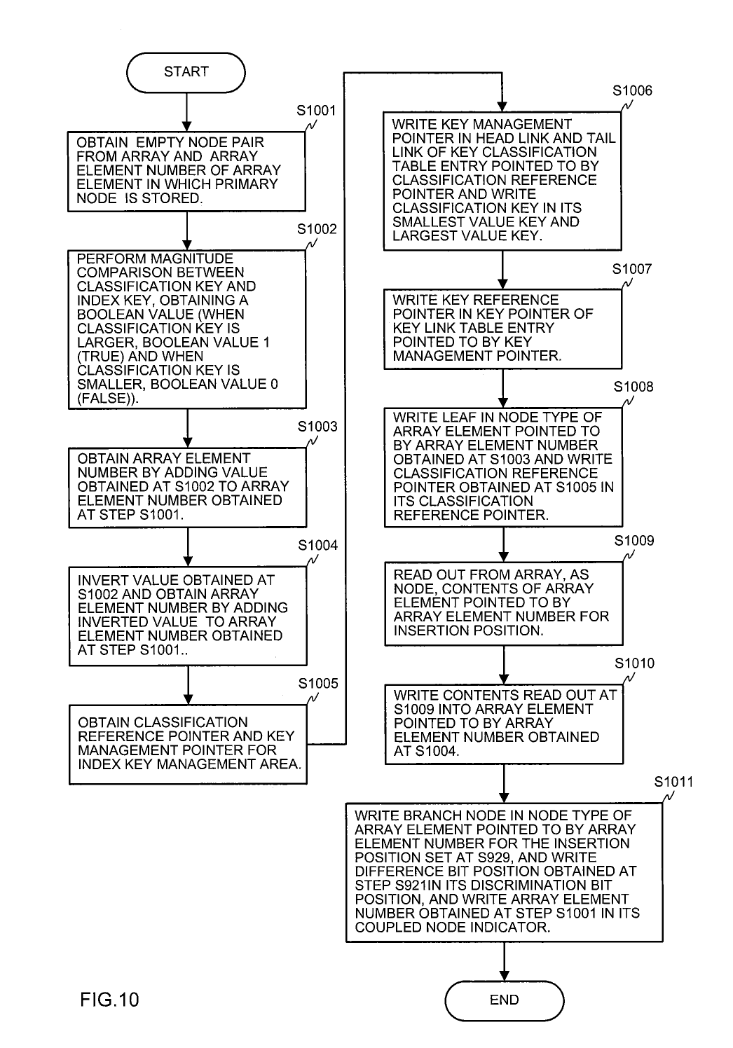

When the determination is that the count value in the search path counter is not the largest value, processing proceeds to step S933, wherein the classification key is inserted at the insertion position, and insertion processing is terminated. One example of the status wherein the node at the insertion position is a leaf node and the count value in the search path counter is not the largest value is the status described above referencing FIG. 6A. And one example of the status after the classification key has been inserted in the insertion position is shown in FIG. 6B. Details of the processing in step S933 is described later referencing FIG. 10.

Conversely, when the determination at step S932 is that the count value in the search path counter is the largest value, processing proceeds to step S934, wherein the classification key is linked to the key link table for the leaf node, and insertion processing is terminated. One example of the status wherein the count value in the search path counter is the largest value is the status described above referencing FIG. 6B. And one example of the status after the classification key has been linked to the key link table for the leaf node is the status shown FIG. 6C.

Also, because the upper level bit values up to the discrimination bit position in the branch node immediately above the leaf node are identical for any key classified into the same block and a key with a bit value differing up to the discrimination bit position in the branch node immediately above the leaf node is classified into a different block, even if the classification key is linked to the leaf node in step S934, the range of the classification key values classified into each block does not overlap. Details of the processing in step S934 is described later referencing FIG. 11.

When the determination at step S927 noted above is that the discrimination bit position does not have a higher positional relationship than the difference bit position obtained at step S921, processing proceeds to step S935.

At step S935, the processing is performed to guarantee that the restriction on the number of levels in the classification tree is not exceeded when the classification key is inserted at the insertion position. In other words, when the classification key is inserted at the insertion position, a check is performed whether the number of levels of leaf nodes below the insertion position exceeds the largest value, and if there is a leaf node exceeding the restriction, the parent node of the node pair including that leaf node is made into a leaf node, and the keys linked to the key link table for the leaf nodes configuring that node pair are linked to the key link table for the parent node that is made a leaf node, and this process is repeated for all leaf nodes below the insertion position. By means of the processing in this step S935, even when a classification key is inserted in the insertion position, the number of levels in the classification tree does not exceed the largest value.

One example of the status wherein the number of levels of leaf nodes below the insertion position exceeds the largest value when a classification key is inserted in the insertion position is the status explained above referencing FIG. 6C. In the status shown in FIG. 6C, the value for the search path counter in leaf node 210d, which is below the insertion position, is the largest value 3.

One example of the status wherein the parent node 210b of the node pair 201d which includes the leaf node 210d is made to be a leaf node and the keys 270e and 271e linked to the key link table for leaf node 210d and the key 271d linked to the key link table for leaf node 211d, which is the other node in the node pair 201d that includes leaf node 210d, are linked to the key link table for the parent node 210b, which has been made a leaf node, is the status shown in FIG. 6D.

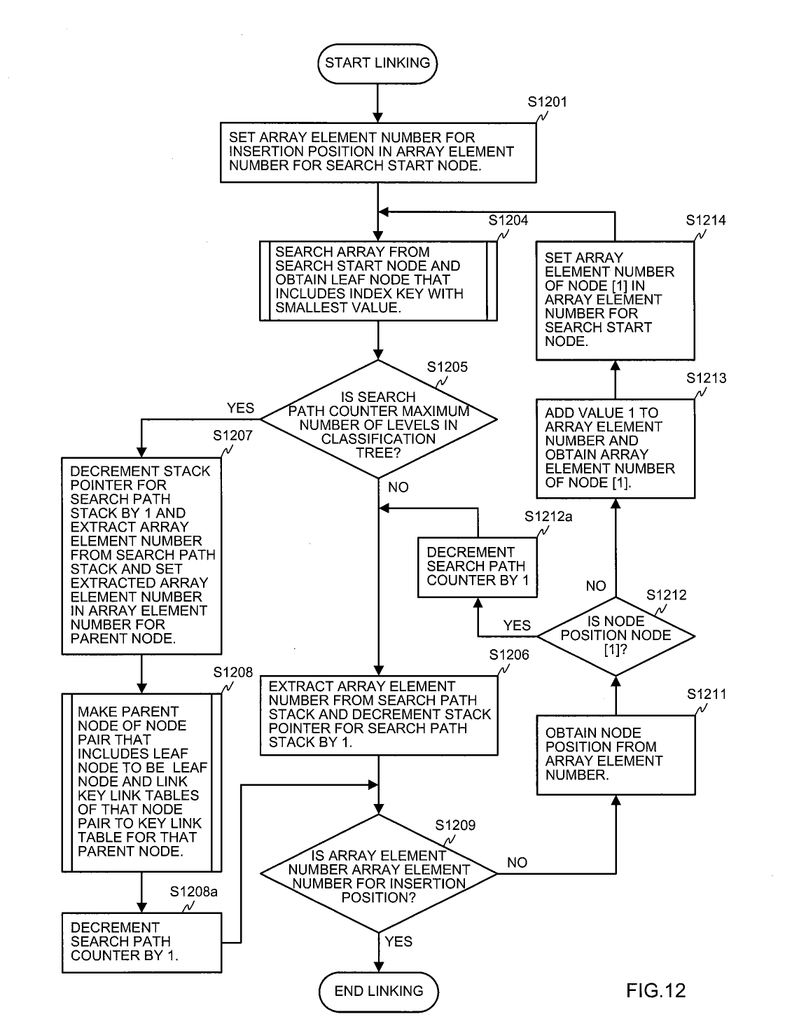

Details of the processing in step S935 is described later referencing FIG. 12.

Following step S935, processing proceeds to step S936 wherein, the same as for the above noted step S933, the classification key is inserted in the insertion position, and insertion processing is terminated. One example of the status wherein, by making the parent node of the node pair that includes the leaf node into a leaf node and by linking to the key link table for the parent node that is made a leaf node the keys linked to the key link table for the leaf nodes that configure the node pair, the value of search path counter has been decremented by 1 from the largest value, and the classification key has been inserted in the insertion position is the status described above referencing FIG. 6E.

Details of the processing in step S936, in the same is as is noted above for step S933, are described below referencing FIG. 10.

FIG. 10 is a drawing showing an example of the processing flow for inserting a classification key in the insertion position in a preferred embodiment of this invention, and it describes details of the processing in steps S933 and S936 shown in FIG. 9C.

As shown in FIG. 10, first, in step S1001, an empty node pair is obtained from the array, and the array element number of the array element that is intended to be the primary node in that node pair is obtained. Next proceeding to step S1002, a magnitude comparison is done between the classification key and the index key set in the processing shown in FIG. 9B, and a boolean value that is the value 1 when the classification key is larger and is the value 0 when it is smaller is obtained.

Then, proceeding to step S1003, the array element number computed by adding the boolean value obtained at step S1002 to the array element number of the primary node obtained at step S1001 is obtained. Also, in step S1004, the array element number computed by adding the logical negation value of the boolean value obtained at step S1002 to the array element number of the primary node obtained at step S1001 is obtained.

Next, proceeding to step S1005, the classification reference pointer and the key management pointer for the index key management area are obtained. Here, the classification reference pointer and the key management pointer for the index key management area are obtained in order to secure the key classification table and key link table entries associated with the leaf node that includes the classification key to be inserted.

Because the number of entries in the key link table is the number of keys to be classified, the acquisition of the key management pointer can be executed by securing beforehand in the index key management area an area of empty entries equal to the number of keys to be classified and by passing successively the starting address of an empty entry as the key management pointer whenever there is an acquisition request.

Although the number of entries in the key classification table, that is, the number eventually necessary, is the number of blocks for classifying the keys, saying it differently, it is the number of leaf nodes in the classification tree, still the acquisition of the classification reference pointer can be executed, the same as for the key link table, by securing beforehand in the index key management area an area of empty entries equal to the number of keys to be classified and by passing successively the starting address of an empty entry as the classification reference pointer whenever there is an acquisition request.

As is noted above in the description of step S935 shown in FIG. 9C, by making the parent node of the node pair that includes the leaf node to be a leaf node, and by linking the keys linked to the key link table for the leaf nodes that configure that node pair to the key link table for the parent node that is made a leaf node, the entries that have become unnecessary can be deleted.

Next, in step S1006, the key management pointer obtained at step S1005 is written in the head link and tail link in the key classification table entry pointed to by the classification reference pointer obtained at step S1005, and the classification key is written in the smallest value key and the largest value key, and in step S1007, the key reference pointer for the index key storage area is written in the key reference pointer in the key link table entry pointed to by the key management pointer. The key reference pointer for the index key storage area is the pointer set in step S701 or step S705 shown in FIG. 7A.

Next, in step S1008, a 1 (leaf node) is written in the node type of the array element pointed to by the array element number obtained at step S1003 and the classification reference pointer obtained at step S1005 is written in the classification reference pointer.

Proceeding to step S1009, the contents of the array element with the array element number in the insertion position are read out from the array, and in step S1010, the contents read out at step S1009 are written in the array element pointed to by the array element number obtained at step S1004. Here, the array element number in the insertion position is the one set at step S929 shown in FIG. 9C.

Finally, in step S1011, a 0 (branch node) is written in the node type of the array element pointed to by the array element number in the insertion position, and the difference bit position obtained at step S921 shown in FIG. 9C is written in discrimination bit position, and the array element number obtained at step S1001 is written in the coupled node indicator, and processing is terminated.

When the example of processing flow shown in FIG. 10 described above is associated with the example shown in FIG. 6A and FIG. 6B described above, the array element number obtained at step S1001 is the coupled node indicator 220b for the node 210b shown in FIG. 6B, the boolean value obtained at step S1002 is a 0, the leaf node generated at step S1008 is the node 210d shown in FIG. 6B, the contents of the array element read in at step S1009 is the node 210b shown in FIG. 6A, the node generated at step S1010 is the node 211d shown in FIG. 6B, and the branch node generated at step S1011 is the node 210b shown in FIG. 6B.

FIG. 11 is a drawing showing an example of the processing flow to link classification keys to the key link table for the leaf node in a preferred embodiment of this invention, and it describes details of the processing in step S917 shown in FIG. 9B and in step S934 shown in FIG. 9C. The processing to link a classification key to the key link table for a leaf node does not consist in a modification to the classification tree but rather is done by rewriting the key classification table and key link table in the index key management area.

As shown in FIG. 11 first, in step S1101, the key management pointer for the index key management area is obtained. Next, proceeding to step S1102, the key reference pointer for the index key storage area is written in the key reference pointer in the key link table pointed to by the key management pointer.

Next, proceeding to step S1103, the tail link in the key classification table entry pointed by the classification reference pointer extracted at step S910 shown in FIG. 9A is read out, and in step S1104, the key management pointer obtained at step S1101 is written into the link in the key link table entry pointed to by the tail link. Then, proceeding to step S1105, the key management pointer is also written into the tail link in the key classification table entry pointed by the classification reference pointer extracted at step S910 shown in FIG. 9A.

Next in step S1106, the smallest value key and the largest value key in the key classification table entry pointed by the classification reference pointer extracted at step S910 shown in FIG. 9A are read out, and in step S1107, a determination is made whether the classification key is smaller than the smallest value key.

If the classification key is smaller than the smallest value key, in step S1108, the classification key is written into the smallest value key in the key classification table entry pointed by the classification reference pointer extracted at step S910 shown in FIG. 9A, and processing is terminated.

If the classification key is not smaller than the smallest value key, in step S1109, a determination is made whether the classification key is larger than the largest value key. If the classification key is not larger than the largest value key, processing is terminated, and if the classification key is larger than the largest value key, in step S1110, the classification key is written into the largest value key in the key classification table entry pointed by the classification reference pointer extracted at step S910 shown in FIG. 9A, and processing is terminated.

Also, although the processing flow shown in the above noted example in FIG. 11 is made to be common to both the processing in step S917 shown in FIG. 9B and the processing in step S934 shown in FIG. 9C, because the processing in step S917 shown in FIG. 9B presumes that the value of the classification key lies within the range of the value in the smallest value key and the value in the largest value key, the processing in step S917 shown in FIG. 9B can also be made to be the processing in step S1101 to step S1105.

FIG. 12 is a drawing describing an example of the preparatory processing flow to ensure that the number of levels in the classification tree do not exceed the limit when a classification key is inserted at the insertion position, in a preferred embodiment of this invention. It describes details of the processing in step S935 shown in FIG. 9C. Just as in the description above referencing FIG. 9C, the processing shown in FIG. 12 is executed when there is a determination that the discrimination bit position in the branch node in the search path disposed in the array element pointed to by the insertion position array element number set at step S929 does not have a higher position relationship than the difference bit position obtained at step S921.

Then, when the classification key has been inserted in the insertion position, a check is made whether the number of levels of the leaf nodes below the insertion position does not exceed the largest value, and if there is a leaf node that exceeds the restriction, the parent node of the node pair that includes that leaf node is made a leaf node, and the keys linked to the key link table of the leaf nodes configuring that node pair are linked to the key link table for that parent node, for all the leaf nodes below the insertion position.

Whereat, the processing shown in FIG. 12 to cover all the leaf nodes below the insertion position, the same as for the processing to extract the classification keys stored in the classification tree described above referencing FIG. 7B, is similar to the processing to extract, from a coupled-node tree, index keys in ascending order disclosed in drawing 10 in Japanese patent JP 4271227 B that is related to the application of the same applicants for the present application.

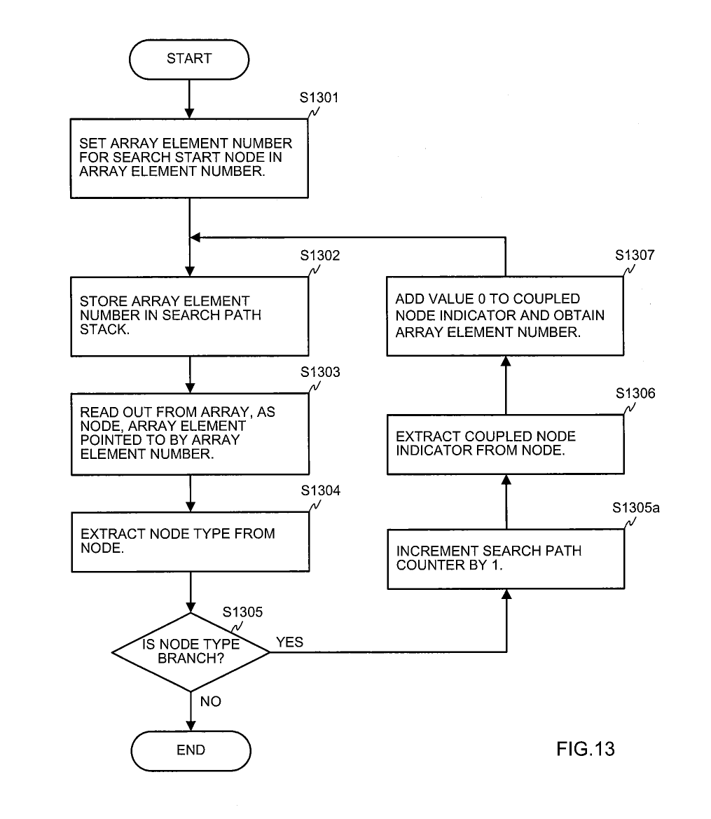

As shown in FIG. 12, first, in step S1201, the array element number of the insertion position is set in the array element number of the search start node, and processing proceeds to step S1204. In step S1204, the array is searched from the search start node, and the leaf node including the smallest value of the index keys is obtained. Here, the array element number for the insertion position is the one set at step S929 shown in FIG. 9C. Details of the processing in step S1204 is described later referencing FIG. 13.

Next, in step S1205, a determination is made whether the count value for the search path counter is the largest value. Here, the count value for the search path counter is the one counted when the leaf node is obtained at step S1204, and it indicates the level in the classification tree wherein is located the leaf node obtained at that point.

When, in step S1205, the determination is made that the count value for the search path counter is not that of the largest value, processing proceeds to step S1206, wherein the array element number is extracted from the search path stack, and the stack pointer for the search path stack is decremented by 1, and processing proceeds to step S1209. The array element number extracted from the search path stack at step S1206 is either the array element number, obtained in step S1204, of the array element disposed in the leaf node that includes the smallest value of the index keys or the array element number pointed to by the stack pointer that is decremented by 1 at step S1206 in the last previous processing loop from step S1206 to step S1212a.

Conversely, when the determination in step S1205 is that the count value for the search path counter is that of the largest value, processing branches to step S1207. At step S1207, the stack pointer for the search path stack is decremented by 1, and the array element number is extracted from the search path stack, and the extracted array element number is set in the array element number of the parent node. Here the parent node is the node immediately above the leaf node, obtained in step S1204, that includes the smallest value of the index keys. The node immediately above a given node is called the parent node of that node, and the node immediately below is called a child node.

Next, in step S1208, the leaf node that is linked to the keys that have been linked to the key link table for the leaf node obtained at step S1204 and the keys that have been linked to the key link table for the leaf node that is a pair to that leaf node is written into the array element of which array element number is set at step S1207, in other words, it is written into the array element of the parent node. Saying it differently, the branch node (parent node) immediately above the leaf node obtained at step S1204 is made to be a leaf node, and the keys that have been linked to the key link table for the leaf node obtained at step S1204 and the keys that have been linked to the key link table for the leaf node that is a pair to that leaf node are linked to the key link table for the parent node that is made a leaf node.

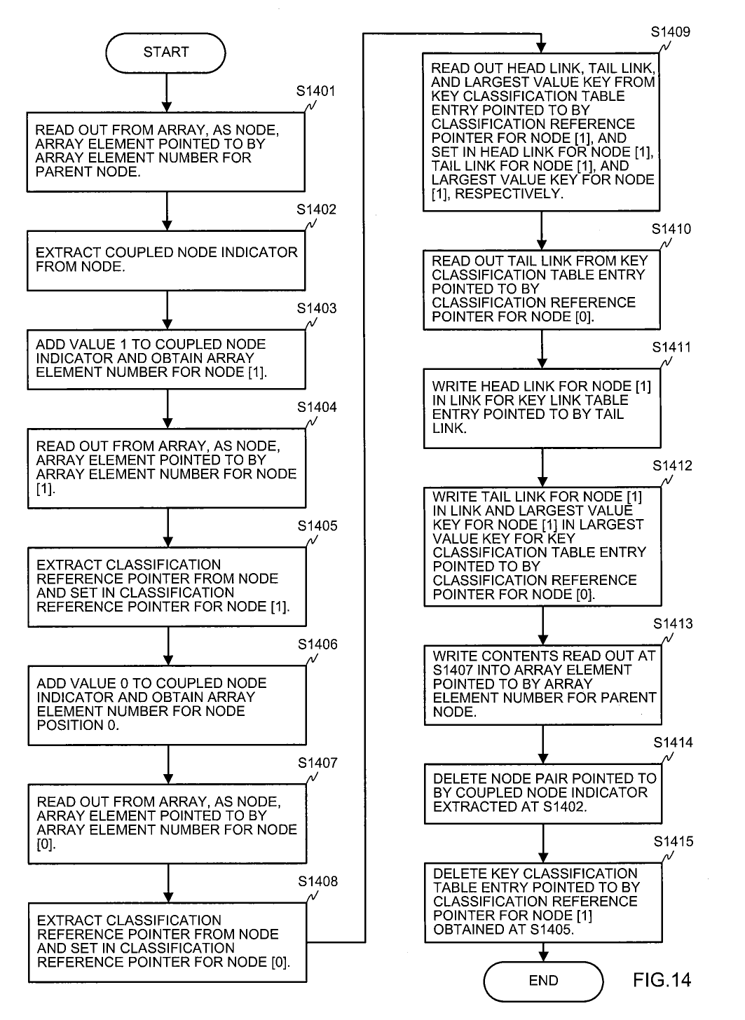

Details of the processing in step S1208 are described later referencing FIG. 14.

Next, in step S1208a, the count value for the search path counter is decremented by 1, and processing proceeds to step S1209. Here the count value for the search path counter is decremented by 1 because the number of levels of the leaf node has been decremented by 1 by making the parent node into a leaf node in the processing in the above noted step S1208. By means of this processing, the count value for the search path counter when there is once again a search for the smallest value in step S1204 can be made to coincide with the number of levels in the search path.

At step S1209, a determination is made whether the array element number extracted at step S1206 or step S1207 is the array element number of the insertion position. If the determination result is that the array element number extracted at step S1206 or step S1207 is the array element number of the insertion position, link processing is terminated because the processing of all the leaf nodes below the node at the insertion position has been completed. If the determination result is that the array element number extracted at step S1206 or step S1207 is not the array element number of the insertion position, processing proceeds to step S1211.

At step S1211, a node position is obtained that indicates in which of the array elements of a node pair is stored the node with the array element number extracted at step S1206 or step S1207. The node position can be obtained from the array element number, for example, by knowing that a node [0] is stored in the array element whose array element number is an even number and so forth.

Then, at step S1212, a determination is made whether the node position obtained at step S1211 is that of a node [1]. If the determination at step S1212 is that of a node [1], in step S1212a, the count value of the search path counter is decremented by 1, and a return is made to step S1206.

When the determination at step S1212 is that of a node [0], processing proceeds to step S1213, wherein the array element number is incremented by 1, and the array element number of the node [1] that is a pair to that node is obtained. Then, at step S1214, the array element number of the node [1] obtained at step S1213 is set in the array element number of the search start node, and a return is made to step S1204.

The processing loop of the above noted steps S1204 to S1214 is repeated, while decrementing by 1 the stack pointer for the search path stack at step S1206 or while reducing the number of levels of a leaf node by making the parent node to be a leaf node in the processing from step S1207 to step S1208a, until a determination at step S1209 is made that the array element number extracted from the search path stack is the array element number of the insertion position.

Just as for the example shown in FIG. 6C, if the node immediately below the node at the insertion position is a leaf node and its number of levels is the largest value, at step S1204, the node 210d is obtained as the node that includes the smallest value, and the array element number 220a for the node at the insertion position and the array element number 220b for the array element wherein is disposed node 210d are stored in the search path stack. Because the count value for the search path counter is the largest value, at step S1207, the array element number 220a is extracted, and following the processing in step S1208 and step S1208a, in the determination at step S1209, the determination is that the extracted array element number is the array element number of the insertion position, and processing is terminated.

Supposing we were to change the example in FIG. 6C so that the maximum number of levels in the classification tree becomes 4, then the determination in step S1205 results in processing proceeding to step S1206 and the array element number 220b is extracted from the search path stack, and the determination at step S1209 becomes negative, and step S1214 is reached via step S1211, step S1212, and step S1213. In step S1214, the array element number 220b+1 is set in the array element number for the search start node, and the search for the smallest value in step S1204 is done using node 211d as the search start node, and node 211d is obtained as the leaf node that includes the smallest value of the index keys. Then the processing loop of step S1206 to step S1212a is executed and when, at step S1206, the array element number 220a for the insertion position is extracted, processing is terminated by the determination in step S1209.

When a search for the smallest value is first executed, because the search is made for the leaf node that includes the smallest value in the subtree which has the node at the insertion position as its root node, the node position for that leaf node is a node [0], and the node [1] that configures the same node pair is made the search start node and a search is done for the next smallest value. Finally, a search is done for the leaf node that includes the largest value in the subtree which has the node at the insertion position as its root node. The node position of that leaf node is a node [1], and the processing loop of step S1206 to step S1212a is repeated until the array element number of the insertion position is extracted from the search path stack in step S1206, and the determination at step S1209 is that the array element number is the array element number of the insertion position, and processing is terminated.

FIG. 13 is a drawing describing an example of the processing flow to search for the node with the smallest index key in a preferred embodiment of this invention, and it describes details of the processing in step S1204 shown in FIG. 12.

As shown in FIG. 13, first, in step S1301, the array element number of the search start node is set in the array element number. The array element number of the search start node is set either in step S1201 or step S1214 shown in FIG. 12.

Next, in step S1302, the array element number is stored in the search path stack. Then, at step S1303, the array element pointed to by the array element number is read out from the array as a node, and at step S1304, the node type is extracted from the read-out node, and processing proceeds to step S1305.

At step S1305, a determination is made whether the node type is branch node, and when the determination is that the node type is branch node, processing proceeds to step S1305a, wherein the value in the search path counter is incremented by 1. Next, proceeding to step S1306, the coupled node indicator is extracted from the node, and at step S1307, the value 0 is added to the extracted coupled node indicator, and the result is made to be a new array element number, and a return is made to step S1302.

Thereinafter, the processing from step S1302 to step S1307 is repeated until the node extracted at step S1304 is determined to be a leaf node in step S1305, and when the node extracted at step S1304 is determined to be a leaf node in step S1305, processing is terminated.

Also, although the processing to search for a leaf node that includes the smallest value in the index keys described above referencing FIG. 13 is described such that the coupled-node tree is stored in an array, it is clear that it is not necessary for the coupled-node tree to be stored in an array, and the search for a leaf node that includes the smallest value in the index keys can be done by linking only to the primary node of the two nodes configuring the node pair or only to the node disposed in the storage area adjacent to the primary node until a leaf node is reached.

FIG. 14 is a drawing describing an example of the processing flow to make the parent node of a node pair that includes a leaf node into a leaf node and to link the key link table for that node pair into the key link table for that parent node, and it describes details of the processing in step S1208 shown in FIG. 12. In the processing to link the keys linked to the key link table for the node pair that includes the leaf node to the key link table for the parent node, the classification reference pointers associated with each node that comprises the node pair are consolidated into the classification reference pointer for the parent node.

As shown in FIG. 14 first, in step S1401, the array element pointed to by the array element number for the parent node is read out from the array as a node, and at step S1402, the coupled node indicator is extracted from the read-out node. In the example shown in FIG. 6C, the coupled node indicator 220b for the parent node 210b is extracted.

Next proceeding to step S1403, the value 1 is added to the coupled node indicator, and the array element number for node [1] is obtained. Then, in step S1404, the array element pointed to by the array element number for node [1] is read out from the array as a node, and in step S1405, the classification reference pointer is extracted from the node and is set in the classification reference pointer for node [1]. In the example shown in FIG. 6C, the node 211d pointed to by array element number 220b+1 is read out, and the classification reference pointer 280d is set in the classification reference pointer for node [1], which is a temporary storage area.

Next, proceeding to step S1406, the value 0 is added to the coupled node indicator, and the array element number for node position 0 is obtained. Then, in step S1407, the array element pointed to by the array element number for node [0] is read out from the array as a node, and in step S1408, the classification reference pointer is extracted from the node and is set in the classification reference pointer for node [0]. In the example shown in FIG. 6C, the node 210d pointed to by array element number 220b is read out, and the classification reference pointer 280e is set in the classification reference pointer for node [0], which is a temporary storage area.

Next, in step S1409, the head link, tail link, and largest value key in the key classification table entry pointed to by the classification reference pointer for node [1] are read out and the head link and tail link are set in the head link for node [1] and in the tail link for node [1] respectively, and the largest value key is set in the largest value key for node [1].

Next, in step S1410, the tail link in the key classification table entry pointed to by the classification reference pointer for node [0] is read out, and in step S1411, the head link for node [1] set at step S1409 is written in the link in the key link table entry pointed to by the read-out tail link. Then, in step S1412, the tail link for node [1] is written in the tail link in the key classification table entry pointed to by the classification reference pointer for node [0], and the largest value key for node [1] is written in its largest value key.

By means of the above processing, the classification reference pointer for the parent node that is to be made a leaf node is made to be the classification reference pointer for the child node [0], and, in line with that, the key link table and the key classification table are rewritten. The process, in the above noted step S1411, of writing the head link for node [1] into the link in the key link table entry pointed to by the tail link in the key classification table entry pointed to by the classification reference pointer for node [0] sets the links to the keys that are linked to the key link table for leaf node [1] after the keys that are linked to the key link table for the leaf node [0].

Next, proceeding to step S1413, the contents read out at step S1407 is written in the array element pointed to by the array element number for the parent node. In the examples shown in FIG. 6C and FIG. 6D, the contents of node 210d shown in FIG. 6C is written in node 210b shown in FIG. 6D.

Finally, at step S1414, the node pair pointed to by the coupled node indicator extracted at S1402 is deleted, and at step S1415, the key classification table entry pointed to by the classification reference pointer for node [1] obtained at S1405 is deleted, and processing is terminated.

Next, referencing FIG. 15A and FIG. 15B, the processing is described for searching the array from the search start node and obtaining the leaf node that includes the smallest value of the index keys, and for successively outputting the index keys linked to the key link table for the leaf node. The processing flow shown in the example in FIG. 15A and FIG. 15B describes details of the processing in step S714 shown in FIG. 7B.

FIG. 15A is a drawing describing an example of the processing flow in the prior stage of the processing that searches the array from the search start node, obtains the leaf node with the smallest index key, and successively extracts index keys that are linked to the key link table for the leaf node in a preferred embodiment of this invention. The prior stage of processing shown in the example in FIG. 15A searches the array from the search start node, obtains a leaf node that includes the smallest value of the index keys, and extracts the classification reference pointer from the leaf node.

As shown in FIG. 15A, first, in step S1501, the array element number of the search start node is set in the array element number. Here, the array element number of the search start node is either the array element number for the root node of the classification tree set at step S711 shown in FIG. 7B or the array element number for node [1] set at step S724.

Next, at step S1501a, the array element number is stored in the search path stack, and proceeding to step S1502, the array element pointed to by the array element number is read out from the array as a node. Then at step S1503, the node type is extracted from the read-out node, and processing proceeds to step S1504.

At step S1504, a determination is made whether the node type extracted at step S1503 indicates a branch node. If the node type indicates a branch node, processing proceeds to step S1505, wherein the coupled node indicator is extracted from the node read out at step S1502, and, in step S1506, the value 0 is added to the extracted coupled node indicator, and an array element number is obtained, and a return is made to step S1501a.

Conversely, when the determination in step S1504 is that the node type extracted at step S1503 is a leaf node, processing proceeds to step S1508, wherein the classification reference pointer is extracted from the node read out at step S1502, and processing proceeds to step S1511 shown in FIG. 15B.

FIG. 15B is a drawing describing an example of the processing flow in the latter stage of the processing to search the array from the search start node and to obtain the leaf node with the smallest index key and to successively extract index keys that are linked to the key link table for the leaf node in a preferred embodiment of this invention. The processing of the latter stage shown in the example in FIG. 15B successively extracts the index keys linked to the key link table for the leaf node that is obtained in the processing of the prior stage and that includes the smallest value of the index keys and outputs those keys to the output target.

As shown in FIG. 15B, in step S1511, the head link, tail link and the key output target in the key classification table pointed by the classification reference pointer read out at step S1508 shown in FIG. 15A, and in step S1512, the read-out head link is set in the read out pointer.

Next in step S1513, the key reference pointer and link in the key link table entry pointed to by the read out pointer are read out. Here, the read out pointer is the one set at step S1512 or at step S1516, noted below.

Next in step S1513a, the key pointed to by the key reference pointer read out at step S1513 is read out from the index key storage area, and, in step S1514, the read out key is output to the key output target read out at step S1511, and processing proceeds to step S1515.

At step S1515, a determination is made whether the read out pointer coincides with the tail link, and if they do not coincide, in step S1516, the link read out at step S1513 is set in the read out pointer, and a return is made to step S1513.

When the determination in step S1515 is that the read out pointer coincides with the tail link, processing is terminated because all the index keys linked to the key link table for the leaf node that includes the smallest value of the index keys, which is obtained in the prior stage of processing shown in FIG. 15A, have been output.

The above describes the processing flow that realizes a bit-string key classification method and a distribution method related to a preferred embodiment of this invention. It is clear that the bit-string key classification apparatus and bit-string key distribution apparatus related to this invention can be constructed on a computer by means of a program that executes this processing flow on a computer like the data processing apparatus 301 shown in the example in FIG. 4. Whereat, an example of a function configuration for the bit-string key classification apparatus and bit-string key distribution apparatus related to this invention is described hereinbelow.

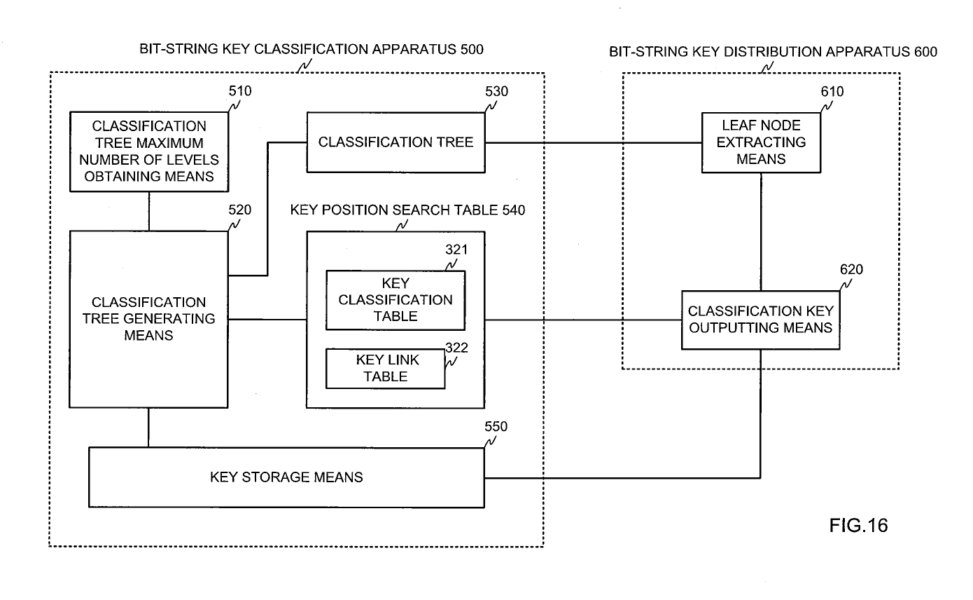

FIG. 16 is a drawing describing an example of a function block configuration for a bit-string key classification/distribution apparatus in a preferred embodiment of this invention. As shown in FIG. 16, the bit-string key classification apparatus 500 includes the classification tree maximum number of levels obtaining means 510, the classification tree generating means 520, and the key storage means 550, and by reading out the bit-string keys to be classified stored in the key storage means 550 as classification keys, and by generating the classification tree 530 and the key position search table 540, within the restriction on the maximum number of levels obtained by the classification tree maximum number of levels obtaining means 510, the bit-string keys to be classified are classified. Key position search table 540 can be made to be the key classification table 321 and the key link table 322.

The bit-string key distribution apparatus 600 includes the leaf node extracting means 610 and the classification key outputting means 620; and the leaf node extracting means 610 successively extracts leaf nodes from the classification tree 530, and the classification key outputting means 620 reads out key access information from the leaf node extracted by the leaf node extracting means 610, and extracts key position information from the key position search table using the key access information, and reads out keys from the key storage means based on the key position information, and outputs them to the output target. Also, although the key output target can be set in the key classification table at the end of classification processing, the key output target can also be set in association with the blocks for classifying the keys to be classified and then the output target can be determined for each extraction of a leaf node from the classification tree.

What is claimed is:

1. A bit-string key classification apparatus that
selects, as classification keys, keys to be classified consisting of a bit string and
classifies the keys to be classified into a plurality of blocks based on each value of the classification keys, comprising:
a key storage means in which the keys to be classified are stored;
a classification tree generating means that
generates a classification tree so configured that
the classification tree is a tree comprising a root node and a node pair, the node pair being a branch node and a leaf node, or a pair of branch nodes, or a pair of leaf nodes located in adjacent storage areas,
wherein
the root node is a node that expresses a starting point of the tree and which is a leaf node when there is one node in the tree and a branch node when there are two or more nodes in the tree, and
the branch node includes a discrimination bit position of a classification key with which a bit string search is performed and position information indicating a position of a primary node, which is one node of a node pair of a link target, and
the leaf node includes key access information used to obtain position information for the classification keys stored in the key storage means, and
wherein
using any arbitrary node in the tree as a search start node,
by repeating linkage successively, at the branch node, to the primary node, or a node located in the storage area adjacent to the primary node, of the node pair of the link target in accordance with a bit value in the classification key at a discrimination bit position included in the branch node, until the leaf node is reached, and
the key access information stored in the leaf node being the result of a search of any arbitrary subtree of the tree using the classification key, taking the search start node as a root node;
a classification tree maximum number of levels obtaining means that
obtains a maximum number of levels for the classification tree corresponding to a number of blocks for classifying the keys to be classified; and wherein
the classification tree generating means includes
a root node generating means that
selects as a classification key one key from the key storage means and
obtains the position information of the classification key and
generates the classification tree wherein
the leaf node that includes the key access information used to obtain the obtained position information of the classification key is made to be the root node
while generating a key position search table that holds information for obtaining the position information using the key access information, and
a classification key inserting means that
further successively selects, as a classification key, one of the keys to be classified from the key storage means and
obtains the position information of the classification key and
inserts into the classification tree the leaf node that includes the key access information used to obtain the obtained position information of the classification key
within the range of the classification tree maximum number of levels obtained by the classification tree maximum number of levels obtaining means
while extending the key position search table by adding, to the key position search table, information for obtaining position information using key access information included in the leaf node that is inserted into the classification tree
or
modifying the key position search table by adding information for obtaining position information of the key to be classified selected as the classification key to the information in the key position search table, for obtaining position information of classification keys using key access information included in an existing leaf node; and
the bit-string key classification apparatus
classifies all the keys to be classified into a plurality of blocks associated with each leaf node
by selecting all the keys to be classified as classification keys and generating the classification tree
while generating the key position search table holding information for obtaining position information of the classification keys using the key access information included in each leaf node in the classification tree.

2. A bit-string key classification apparatus according to claim 1, wherein
the key position search table is configured from
a key classification table with entries associated with the plurality of blocks and
a key link table with entries associated with the keys to be classified, and
the entries in the key classification table include
a head link and a tail link, which are areas respectively holding a key management pointer pointing to an entry in the key link table, and
the entries in the key link table include
an area holding a key reference pointer pointing to position information, in the key storage means, of one of the keys to be classified associated with each of the entries and
a link, which is an area holding the key management pointer, and
the key access information included in a leaf node in the classification tree is a classification reference pointer that points to an entry in the key classification table.

3. A bit-string key classification apparatus according to claim 2, wherein
the entries in the key classification table also include
a smallest value key which is an area holding a smallest value among keys classified into the associated block and
a largest value key which is an area holding a largest value among the keys classified into the associated block, and
the root node generating means
selects one key from the key storage means and
reads out the key as a classification key and
obtains the position information of the classification key
while obtaining a classification reference pointer pointing to an empty entry in the key classification table and
generates the classification tree in which the leaf node that includes the classification reference pointer is made to be the root node, and furthermore
obtains the key management pointer pointing to an empty entry in the key link table and
stores the key management pointer in the head link and the tail link of the obtained key classification table entry and
stores the read-out classification key in the smallest value key and the largest value key
while storing the obtained position information in the key reference pointer of the obtained key link table entry, and
the classification key inserting means includes
a searching means that
further successively selects one key from the key storage means and
reads out the key as a classification key and
obtains the position information of the classification key
while obtaining a classification reference pointer that is the result of a search using the classification key and using the root node as a search start node, and
a first classification key linking means that
obtains a key management pointer pointing to an empty entry in the key link table and
stores the position information obtained by the searching means in the key reference pointer in the key link table entry pointed to by the key management pointer
while adding the information for obtaining the position information of the classification key using the classification reference pointer to the key classification table and the key link table by storing the key management pointer in the link in the key link table entry pointed to by the tail link in the key classification table entry pointed to by the classification reference pointer, and
a second classification key linking means that
obtains a key management pointer pointing to an empty entry in the key link table and
stores the position information obtained by the searching means in the key reference pointer in the key link table entry pointed to by the key management pointer
while adding the information for obtaining the classification key position information using the classification reference pointer to the key classification table and the key link table by storing the key management pointer in the link in the key link table entry pointed to by the tail link in the key classification table entry pointed to by the classification reference pointer, and,
if the classification key is smaller than the smallest value key in the key classification table entry pointed to by the classification reference pointer,
writes the classification key in the smallest value key and, conversely,
if the classification key is larger than the largest value key in the key classification table entry pointed to by the classification reference pointer,
writes the classification key in the largest value key, and
a node pair insertion position deciding means that
makes a bit string comparison between the classification key and a search result key, the search result key being either the smallest value key or largest value key in the key classification table entry pointed to by the classification reference pointer obtained by the searching means and
obtains a difference bit position, which is the first bit position with a differing bit value in the bit string comparison, and
determines, by the relative position relationship between the difference bit position and discrimination bit positions in the branch nodes on the link path created when the classification reference pointer is obtained by the searching means, position information of a node that is the link source for a node pair to be inserted into the classification tree as an insertion position, the node pair consisting of the leaf node that includes the classification reference pointer used to obtain the position information of the classification key and a node that is a pair with the leaf node and
a node pair inserting means that
inserts the node pair by
making the contents of the node that is a pair to the leaf node that includes the classification reference pointer used to obtain the position information of the classification key to be the contents of the node at the insertion position and
writing an indicator in the node type of the node at the insertion position showing that the node is a branch node and
writing the difference bit position in the discrimination bit position and
writing in the coupled node indicator the position information of the primary node in the node pair whose insertion position is obtained by the node pair insertion position deciding means, and
a node pair linking means that
performs a check whether the number of levels of leaf nodes lower than the node at the insertion position exceeds the maximum number of levels when the node pair is inserted in the insertion position for a node pair decided by the node pair insertion position deciding means and,
if a number of levels of a leaf node exceeds the maximum number of levels,
performs processing to guarantee that the maximum number of levels is not exceeded even when the node pair is inserted
by making the parent node, which is the node directly above the node pair that includes the leaf node, to be a leaf node and,
based on classification reference pointers and the key classification table data pointed to by the classification reference pointers in the leaf nodes configuring the node pair,
determining the classification reference pointer of the parent node that is made to be a leaf node while updating the key classification table data pointed to by the classification reference pointers and related key link table data and
deleting the node pair,
for all the leaf nodes at a lower level than the node at the insertion position, and
if the value of the read-out classification key is in the range between the value of the smallest value key and the value of the largest value key in the key classification table entry pointed to by the classification reference pointer obtained by the searching means,
the first classification key linking means
adds the information for obtaining the classification key position information using the classification reference pointer to the key classification table and the key link table, and
if the value of the read-out classification key is outside the range between the value of the smallest value key and the value of the largest value key in the key classification table entry pointed to by the classification reference pointer obtained by the searching means,
the node pair insertion position deciding means determines the position information of the node that is the link source of the node pair as the insertion position of the node pair, and
when the node at the determined insertion position is a leaf node and the number of levels of the leaf node is the maximum number of levels,
the second classification key linking means adds the information for obtaining the classification key position information using the classification reference pointer to the key classification table and the key link table
while
if the classification key is smaller than the smallest value key in the key classification table entry pointed to by the classification reference pointer,
writing the classification key in the smallest value key and, conversely,
if the classification key is larger than the largest value key in the key classification table entry pointed to by the classification reference pointer,
writing the classification key in the largest value key, and
when the node at the determined insertion position is a leaf node and the number of levels of the leaf node is not the maximum number of levels, the node pair inserting means inserts the node pair, and
when the node at the insertion position determined by the node pair insertion position determining means is a branch node,
the node pair linking means performs the processing to guarantee that the maximum number of levels is not exceeded even if the node pair is inserted, and
the node pair inserting means inserts the node pair.

4. A bit-string key classification apparatus according to claim 3, wherein
the classification tree is stored in an array and
the position information indicating the position of the primary node is an array element number of an array element in the array in which the primary node is stored.

5. A bit-string key distribution apparatus that extracts and outputs, for each block, keys in a plurality of blocks, which keys are classified into the plurality of blocks by the bit-string key classification apparatus according to claim 1, comprising:
a leaf node extracting means that
extracts a leaf node successively from the classification tree; and
a classification key output means that
reads out key access information from the leaf node that is extracted by the leaf node extracting means,
extracts key position information from the key position search table using the key access information,
reads out keys from the key storage means based on the key position information, and
outputs the read-out keys to an output target corresponding to each block.

6. A bit-string key distribution apparatus according to claim 5, wherein
the key position search table is configured from
a key classification table with entries associated with the plurality of blocks and
a key link table with entries associated with the keys to be classified, and
the entries in the key classification table include
a head link and a tail link, which are areas respectively holding a key management pointer pointing to an entry in the key link table, and
the entries in the key link table include
an area holding a key reference pointer pointing to position information, in the key storage means, of one of the keys to be classified associated with each of the entries and
a link, which is an area holding the key management pointer, and
the key access information included in a leaf node in the classification tree is a classification reference pointer that points to an entry in the key classification table.

7. A bit-string key distribution apparatus according to claim 6, wherein
the classification tree is stored in an array and
the position information indicating the position of the primary node is the array element number of an array element in the array in which the primary node is stored.

8. A bit-string key classification method wherein
a bit-string classification apparatus with a key storage means in which keys to be classified consisting of bit strings are stored
selects, as classification keys, the keys to be classified and classifies the keys to be classified into a plurality of blocks based on the value of the classification key, comprising:
a classification tree maximum number of levels obtaining step that
obtains a maximum number of levels in a classification tree, which the maximum number is a function of the number of blocks into which the keys to be classified are classified;
a classification tree generating step that
generates a classification tree so configured that the classification tree is a tree comprising a root node and a node pair, the node pair being a branch node and a leaf node, or a pair of branch nodes, or a pair of leaf nodes located in adjacent storage areas,
wherein
the root node is a node that expresses a starting point of the tree and which is a leaf node when there is one node in the tree and a branch node when there are two or more nodes in the tree, and
the branch node includes a discrimination bit position of a classification key with which a bit string search is performed and a position information indicating a position of a primary node, which is one node of a node pair of a link target, and
the leaf node includes key access information used to obtain position information for the classification keys stored in the key storage means, and
wherein
using any arbitrary node in the tree as the search start node,
by repeating linkage successively, at the branch node, to the primary node, or a node located in the storage area adjacent to the primary node, of the node pair of the link target in accordance with a bit value in the classification key at a discrimination bit position included in the branch node, until the leaf node is reached, and
the key access information stored in the leaf node being the result of a search of any arbitrary subtree of the tree using the classification key, taking the search start node as a root node; and wherein
the classification tree generating step includes steps of
a root node generating step that
selects as a classification key one key from the key storage means and obtains the position information of the classification key and
generates the classification tree wherein the leaf node that includes the key access information used to obtain the obtained position information of the classification key is made to be the root node while generating a key position search table that holds information for obtaining the position information using the key access information, and
a classification key inserting step that
further successively selects, as a classification key, one of the keys to be classified from the key storage means and obtains the position information of the classification key and
inserts into the classification tree the leaf node that includes the key access information used to obtain the obtained position information of the classification key within the range of the classification tree maximum number of levels obtained at the classification tree maximum number of levels obtaining step
while extending the key position search table by adding, to the key position search table, information for obtaining position information using key access information included in the leaf node that is inserted into the classification tree
or
modifying the key position search table by adding information for obtaining position information of the key to be classified selected as the classification key to the information in the key position search table, for obtaining position information of classification keys using key access information included in an existing leaf node; and
the bit-string key classification apparatus
classifies all the keys to be classified into a plurality of blocks associated with each leaf node
by selecting all the keys to be classified as classification keys and generating the classification tree
while generating the key position search table holding information for obtaining position information of the classification keys using the key access information included in each leaf node in the classification tree.

9. A bit-string key classification method according to claim 8, wherein
the key position search table is configured from
a key classification table with entries associated with the plurality of blocks and
a key link table with entries associated with the keys to be classified, and
the entries in the key classification table include
a head link and a tail link, which are areas respectively holding a key management pointer pointing to an entry in the key link table, and
the entries in the key link table include
an area holding a key reference pointer pointing to position information, in the key storage means, of one of the keys to be classified associated with each of the entries and
a link, which is an area holding the key management pointer, and
the key access information included in a leaf node in the classification tree is a classification reference pointer that points to an entry in the key classification table.

10. A bit-string key classification method according to claim 9, wherein
the entries in the key classification table also include
a smallest value key which is an area holding a smallest value among keys classified into the associated block and
a largest value key which is an area holding a largest value among the keys classified into the associated block, and
the root node generating step
selects one key from the key storage means and
reads out the key as a classification key and
obtains the position information of the classification key
while obtaining a classification reference pointer pointing to an empty entry in the key classification table and
generates the classification tree in which the leaf node that includes the classification reference pointer is made to be the root node, and furthermore
obtains the key management pointer pointing to an empty entry in the key link table and
stores the key management pointer in the head link and the tail link of the obtained key classification table entry and
stores the read-out classification key in the smallest value key and the largest value key
while storing the obtained position information in the key reference pointer of the obtained key link table entry, and
the classification key inserting step includes steps of
a searching step that
further successively selects one key from the key storage means and
reads out the key as a classification key and
obtains the position information of the classification key
while obtaining a classification reference pointer that is the result of a search using the classification key and using the root node as a search start node, and
a first classification key linking step that
obtains a key management pointer pointing to an empty entry in the key link table and
stores the position information obtained at the searching step in the key reference pointer in the key link table entry pointed to by the key management pointer
while adding the information for obtaining the position information of the classification key using the classification reference pointer to the key classification table and the key link table by storing the key management pointer in the link in the key link table entry pointed to by the tail link in the key classification table entry pointed to by the classification reference pointer, and
a second classification key linking step that
obtains a key management pointer pointing to an empty entry in the key link table and
stores the position information obtained at the searching step in the key reference pointer in the key link table entry pointed to by the key management pointer
while adding the information for obtaining the classification key position information using the classification reference pointer to the key classification table and the key link table by storing the key management pointer in the link in the key link table entry pointed to by the tail link in the key classification table entry pointed to by the classification reference pointer, and,
if the classification key is smaller than the smallest value key in the key classification table entry pointed to by the classification reference pointer, writes the classification key in the smallest value key and, conversely,
if the classification key is larger than the largest value key in the key classification table entry pointed to by the classification reference pointer, writes the classification key in the largest value key, and
a node pair insertion position deciding step that
makes a bit string comparison between the classification key and a search result key, the search result key being either the smallest value key or largest value key in the key classification table entry pointed to by the classification reference pointer obtained at the searching step and
obtains a difference bit position, which is the first bit position with a differing bit value in the bit string comparison, and
determines, by the relative position relationship between the difference bit position and discrimination bit positions in the branch nodes on the link path created when the classification reference pointer is obtained at the searching step, position information of a node that is the link source for a node pair to be inserted into the classification tree as an insertion position, the node pair consisting of the leaf node that includes the classification reference pointer used to obtain the position information of the classification key and a node that is a pair with the leaf node, and
a node pair inserting step that
inserts the node pair by
making the contents of the node that is a pair to the leaf node that includes the classification reference pointer used to obtain the position information of the classification key to be the contents of the node at the insertion position and
writing an indicator in the node type of the node at the insertion position showing that the node is a branch node and
writing the difference bit position in the discrimination bit position and
writing in the coupled node indicator the position information of the primary node in the node pair whose insertion position is obtained at the node pair insertion position deciding step, and
a node pair linking step that
performs a check whether the number of levels of leaf nodes lower than the node at the insertion position exceeds the maximum number of levels when the node pair is inserted in the insertion position for a node pair decided at the node pair insertion position deciding step and,
if a number of levels of a leaf node exceeds the maximum number of levels,
performs processing to guarantee that the maximum number of levels is not exceeded even when the node pair is inserted
by making the parent node, which is the node directly above the node pair that includes the leaf node, to be a leaf node and, based on classification reference pointers and the key classification table data pointed to by the classification reference pointers in the leaf nodes configuring the node pair,
determining the classification reference pointer of the parent node that is made to be a leaf node while updating the key classification table data pointed to by the classification reference pointers and related key link table data and
deleting the node pair,
for all the leaf nodes at a lower level than the node at the insertion position, and
if the value of the read-out classification key is in the range between the value of the smallest value key and the value of the largest value key in the key classification table entry pointed to by the classification reference pointer obtained at the searching step,
the first classification key linking step
adds the information for obtaining the classification key position information using the classification reference pointer to the key classification table and the key link table, and
if the value of the read-out classification key is outside the range between the value of the smallest value key and the value of the largest value key in the key classification table entry pointed to by the classification reference pointer obtained at the searching step,
the node pair insertion position deciding step determines the position information of the node that is the link source of the node pair as the insertion position of the node pair, and
when the node at the determined insertion position is a leaf node and the number of levels of the leaf node is the maximum number of levels,
the second classification key linking step adds the information for obtaining the classification key position information using the classification reference pointer to the key classification table and the key link table
while
if the classification key is smaller than the smallest value key in the key classification table entry pointed to by the classification reference pointer,
writing the classification key in the smallest value key and, conversely,
if the classification key is larger than the largest value key in the key classification table entry pointed to by the classification reference pointer,
writing the classification key in the largest value key, and
when the node at the determined insertion position is a leaf node and the number of levels of the leaf node is not the maximum number of levels, the node pair inserting step inserts the node pair, and
when the node at the insertion position determined at the node pair insertion position determining step is a branch node,
the node pair linking step performs the processing to guarantee that the maximum number of levels is not exceeded even if the node pair is inserted, and
the node pair inserting step inserts the node pair.

11. A bit-string key classification method according to claim 10, wherein
the classification tree is stored in an array and
the position information indicating the position of the primary node is an array element number of an array element in the array in which is the primary node is stored.

12. A bit-string key distribution method wherein
a bit-string key distribution apparatus
extracts and outputs, for each block, keys in a plurality of blocks, which keys are classified into the plurality of blocks by the bit-string key classification apparatus according to claim 1, comprising:
a leaf node extracting step that
extracts a leaf node successively from the classification tree; and
a classification key output step that
reads out key access information from the leaf node that is extracted at the leaf node extracting step,
extracts key position information from the key position search table using the key access information,
reads out keys from the key storage means based on the key position information, and
outputs the read-out keys to an output target corresponding to each block.

13. A bit-string key distribution method according to claim 12, wherein
the key position search table is configured from
a key classification table with entries associated with the plurality of blocks and
a key link table with entries associated with the keys to be classified, and
the entries in the key classification table include
a head link and a tail link, which are areas respectively holding a key management pointer pointing to an entry in the key link table, and
the entries in the key link table include
an area holding a key reference pointer pointing to position information, in the key storage means, of one of the keys to be classified associated with each of the entries and
a link, which is an area holding the key management pointer, and
the key access information included in a leaf node in the classification tree is a classification reference pointer that points to an entry in the key classification table.

14. A bit-string key distribution method according to claim 13, wherein
the classification tree is stored in an array and
the position information indicating the position of the primary node is the array element number of an array element in the array in which the primary node is stored.

15. A program that a computer is caused to execute,
for performing the bit-string key classification method according to claim 8.

16. A computer readable storage medium storing a program that
a computer is caused to execute,
for performing the bit-string key classification method according to claim 8.

17. A program that a computer is caused to execute, for performing the bit-string key distribution according to claim 12.

18. A computer readable storage medium containing a program that
a computer is caused to execute, for performing the bit-string key distribution method according to claim 12.

19. A data configuration used by a bit-string key distribution apparatus that
outputs to a plurality of output targets bit-string keys stored in a key storage means and classified into a plurality of blocks, comprising:
a classification tree comprising a root node and a node pair, the node pair being a branch node and a leaf node, or a pair of branch nodes, or a pair of leaf nodes, located in adjacent storage areas,
wherein
the root node is a node that expresses a starting point of the tree and which is a leaf node when there is one node in the tree and a branch node when there are two or more nodes in the tree, and
the branch node includes a discrimination bit position of a classification key with which a bit string search is performed and position information indicating a position of a primary node, which is one node of a node pair of a link target, and
the leaf node includes a key access information used to obtain position information for the classification keys stored in the key storage means, and
wherein
using any arbitrary node in the tree as the search start node,
by repeating linkage successively, at the branch node, to the primary node, or a node located in the storage area adjacent to the primary node, of the node pair of the link target in accordance with a bit value in the classification key at a discrimination bit position included in the branch node, until the leaf node is reached, and
the key access information stored in the leaf node being the result of a search of any arbitrary subtree of the tree using the classification key, taking the search start node as a root node;
a key position search table holding information for obtaining key position information using the key access information; and wherein
the bit-string key distribution method according to claim 12 is enabled to execute by means of the classification tree and the key position search table.

20. A data configuration according to claim 19, wherein
the key position search table is configured from
a key classification table with entries associated with the plurality of blocks and
a key link table with entries associated with the keys to be classified, and
the entries in the key classification table include
a head link and a tail link, which are areas respectively holding a key management pointer pointing to an entry in the key link table, and
the entries in the key link table include
an area holding a key reference pointer pointing to position information, in the key storage means, of one of the keys to be classified associated with each of the entries and
a link, which is an area holding the key management pointer, and
the key access information included in a leaf node in the classification tree is a classification reference pointer that points to an entry in the key classification table.

21. A data configuration according to claim 20, wherein
the classification tree is stored in an array and
the position information indicating the position of the primary node is the array element number of an array element in the array in which the primary node is stored.

22. A computer readable storage medium storing the data configuration according to claim 19.
